(19) United States
(12) Patent Application Publication
(10) Pub. No.: US 2009/0103893 A1
(43) Pub. Date: Apr. 23, 2009

(54) Recording Schedule Sharing System and Recording Schedule Sharing Apparatus

(75) Inventors: Yukimasa Sugino, Tokyo (JP); Susumu Oka, Tokyo (JP); Masami Matsubara, Tokyo (JP); Shinji Akatsu, Tokyo (JP); Shin Miura, Tokyo (JP); Shigeru Imai, Tokyo (JP); Takehiko Hanada, Tokyo (JP)

Correspondence Address: BIRCH STEWART KOLASCH & BIRCH, PO BOX 747, FALLS CHURCH, VA, 22040-0747, US

(73) Assignee: MITSUBISHI ELECTRIC CORPORATION, Tokyo (JP)

(21) Appl. No.: 11/920,424

(22) PCT Filed: May 17, 2005
(86) PCT No.: PCT/JP2005/008989

§ 371 Date: Nov. 15, 2007

(51) Int. Cl. H04N 5/91

(52) U.S. Cl. 386/83; 386/E05.001

(57) ABSTRACT

A recording reservation common share system includes a recording schedule sharing apparatus 1A which makes a request for recording schedule information, and which acquires and checks recording schedule information provided thereto, and recording schedule sharing apparatuses 1B and 1C each of which receive a request for recording schedule information from the recording schedule sharing apparatus 1A, and provides the recording schedule information held thereby to the recording schedule sharing apparatus 1A.

### FIELD OF THE INVENTION

The present invention relates to a recording schedule sharing system which shares recording schedule information among two or more apparatuses, and a recording schedule sharing apparatus.

### BACKGROUND OF THE INVENTION

For example, patent reference 1 discloses, as a conventional recording apparatus, an apparatus which when it will not be able to record a program for a reason that its broadcast time coincides with that of another program scheduled to be recorded, sends a message indicating a recording request to another recording apparatus, thereby enabling recording of the program which will not be able to be recorded.

Furthermore, for example, patent reference 2 also discloses a method of, when a program will not be able to be recorded, solving this problem by providing the user with a shortcut for making a request of his or her friend or the like to record the program by sending an e-mail or calling.

In addition, for example, patent reference 3 discloses a recording apparatus in which a user's unit registers recording reservation information, as well as information indicating a destination of provision of the recording reservation information, into a server, and the recording reservation information is informed to a user's unit which is the provision destination via the server.

[Patent reference 1] JP,8-56352,A (see paragraph numbers 0062 to 0070)
[Patent reference 2] JP,2004-153333,A (see paragraph numbers 0016 to 0017)
[Patent reference 3] JP,2004-64495,A (see paragraph numbers 0113 to 0115 and FIG. 21)

Because conventional recording apparatuses shown in above-mentioned patent references 1 and 2 are constructed as mentioned above, a problem with the conventional recording apparatuses is that because an apparatus which has made a request of another apparatus for recording of a program in behalf thereof does not know the recording schedules of the other apparatus, when the other apparatus cannot accept the request for the recording in behalf of the apparatus and therefore refuses to carry out the recording, the apparatus has to select a still another apparatus to make a request of this other apparatus for the recording again.

A problem with the conventional recording apparatus shown in above-mentioned patent reference 3 is that because a user who uses an apparatus which provides recording reservation information specifies, as a destination of provision of the recording reservation information, another apparatus to which the user desires to notify the recording reservation information, the recording apparatus is unsuitable for an apparatus which desires to receive provision of the information (i.e., an apparatus which makes a request for recording of a program in behalf thereof) to find out another apparatus of which the apparatus desires to make a request for the recording in behalf thereof.

The present invention is made in order to solve the above-mentioned problems, and it is therefore an object of the present invention to provide a recording schedule sharing system which shares recording schedule information among two or more apparatuses, and, as a result, causes an apparatus to make a request for recording of a program in behalf thereof efficiently, thereby further improving the convenience of the system, and a recording schedule sharing apparatus.

### DISCLOSURE OF THE INVENTION

In accordance with the present invention, there is provided a recording schedule sharing system including: a first recording schedule sharing apparatus which makes a request for recording schedule information, and which acquires and checks recording schedule information provided thereto; and a second recording schedule sharing apparatus which receives the request for recording schedule information from the first recording schedule sharing apparatus, and which provides recording schedule information held thereby to the first recording schedule sharing apparatus.

The present invention offers an advantage of being able to cause the first recording schedule sharing apparatus to make a request for recording in behalf thereof efficiently, thereby improving the convenience of the system.

### BRIEF DESCRIPTION OF THE FIGURES

FIG. 1 is a diagram showing the structure of a recording schedule sharing system in accordance with Embodiment 1 of the present invention;

FIG. 2 is a block diagram showing the structure of a recording schedule sharing apparatus in accordance with Embodiment 1 of the present invention;

FIG. 3 is a block diagram showing the structure of the recording schedule sharing apparatus in accordance with Embodiment 1 of the present invention;

FIG. 4 is a block diagram showing the structure of a recording schedule sharing apparatus in accordance with Embodiment 2 of the present invention;

FIG. 5 is a diagram showing the structure of a recording schedule sharing system in accordance with Embodiment 3 of the present invention;

FIG. 6 is a block diagram showing the structure of a recording schedule sharing apparatus in accordance with Embodiment 4 of the present invention;

FIG. 7 is a sequence diagram for explaining the operation of the recording schedule sharing apparatus in accordance with Embodiment 4 of the present invention;

FIG. 8 is a flow chart for explaining a process of checking the recording schedules of another apparatus which is carried out by a recording schedule information processing means of the recording schedule sharing apparatus in accordance with Embodiment 4 of the present invention;

FIG. 9 is a block diagram showing the structure of a recording schedule sharing apparatus in accordance with Embodiment 8 of the present invention;

FIG. 10 is a sequence diagram for explaining the operation of the recording schedule sharing apparatus in accordance with Embodiment 8 of the present invention;

FIG. 11 is a flow chart explaining a process of checking the recording schedules of another apparatus which is carried out by a recording schedule information processing means of the recording schedule sharing apparatus in accordance with Embodiment 8 of the present invention;

FIG. 12 is a sequence diagram for explaining an operation of rearranging a recording schedule in a recording schedule sharing system in accordance with Embodiment 9 of the present invention;

FIG. 13 is a sequence diagram for explaining another operation of rearranging a recording schedule in the recording schedule sharing system in accordance with Embodiment 9 of the present invention;

FIG. 14 is a sequence diagram explaining an operation when notifying information about the capability of a recording schedule sharing apparatus in the recording schedule sharing system in accordance with Embodiment 9 of the present invention;

FIG. 15 is a sequence diagram explaining an operation when a user selects an apparatus of which recording is requested in a recording schedule sharing system in accordance with Embodiment 13 of the present invention;

FIG. 16 is a block diagram showing the structure of a recording schedule sharing apparatus in accordance with Embodiment 14 of the present invention;

FIG. 17 is a sequence diagram explaining an operation when making a recording request with information about a result of inquiry about whether a content can be duplicated being included in a recording request message in a recording schedule sharing system of Embodiment 15 of the present invention;

FIG. 18 is a block diagram showing the structure of a recording schedule sharing apparatus in accordance with Embodiment 16 of the present invention;

FIG. 19 is a sequence diagram for explaining the operation of a recording schedule sharing system in accordance with Embodiment 16 of the present invention;

FIG. 20 is a block diagram showing the structure of a recording schedule sharing apparatus in accordance with Embodiment 17 of the present invention;

FIG. 21 is a flow chart for explaining a process of checking the recording schedule and the viewing-and-listening schedule of another apparatus which is carried out by a recording/viewing-and-listening schedule information processing means of the recording schedule sharing apparatus in accordance with Embodiment 17 of the present invention;

FIG. 22 is a block diagram showing the structure of a recording schedule sharing apparatus in accordance with Embodiment 20 of the present invention; and

FIG. 23 is a sequence diagram for explaining the operation of a recording schedule sharing system in accordance with Embodiment 20 of the present invention.

### PREFERRED EMBODIMENTS OF THE INVENTION

Hereafter, in order to explain this invention in greater detail, the preferred embodiments of the present invention will be described with reference to the accompanying drawings.

### Embodiment 1

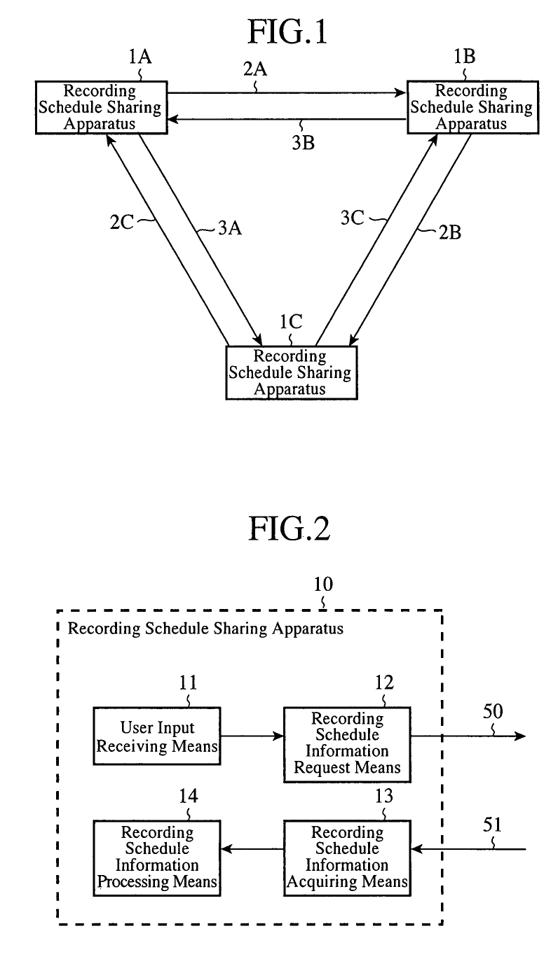

FIG. 1 is a diagram showing the structure of a recording schedule sharing system in accordance with Embodiment 1 of the present invention. In FIG. 1, recording schedule sharing apparatuses 1A, 1B, and 1C transmit and receive recording schedule information request messages 2A, 2B, and 2C or pieces of recording schedule information 3A, 3B, and 3C to and from another apparatus, respectively. At least one of the recording schedule sharing apparatuses 1A, 1B, and 1C has at least a function of providing recording schedule information to another apparatus, and at least one of the recording schedule sharing apparatuses 1A, 1B, and 1C has at least a function of acquiring recording schedule information from another apparatus.

Next, the operation of the recording schedule sharing system will be explained.

Hereafter, the outline of the operation of this recording schedule sharing system will be explained assuming that the recording schedule sharing apparatus 1A in FIG. 1 has a function of acquiring recording schedule information from another apparatus, and each of the recording schedule sharing apparatuses 1B and 1C has a function of providing recording schedule information to another apparatus.

For example, in a case in which because a user who uses the recording schedule sharing apparatus 1A cannot record a television program, which he or she desires to watch, by himself or herself, the user desires to know the recording schedules of each of the recording schedule sharing apparatuses 1B and 1C of another user, such as the user's friend or acquaintance, the recording schedule sharing apparatus 1A transmits recording schedule information request messages 2A and 3A with which the recording schedule sharing apparatus 1A makes a request for provision of recording schedule information to the other recording schedule sharing apparatuses 1B and 1C, respectively, according to the user's operation. When receiving the recording schedule information request messages 2A and 3A, the other recording schedule sharing apparatuses 1B and 1C transmit two pieces of recording schedule information 3B and 2C thereof to the recording schedule sharing apparatus 1A, respectively. The user of the recording schedule sharing apparatus 1A thus gets to know the acquired recording schedule information of each of the other recording schedule sharing apparatuses 1B and 1C, and, by using this information, the user can make a request for, for example, recording of a television program which he or she desires to watch in behalf of the user.

Next, the details of the operation of the recording schedule sharing system shown in FIG. 1 will be explained.

FIG. 2 is a block diagram showing the structure of an information recording schedule sharing apparatus for use in the recording schedule sharing system shown in FIG. 1, which makes a request of another apparatus for recording schedule information and then acquires the recording schedule information from the other apparatus, i.e., the recording schedule sharing apparatus 1A in this Embodiment 1. This recording schedule sharing apparatus 10 is provided with a user input receiving means 11, a recording schedule information request means 12, a recording schedule information acquiring means 13, and a recording schedule information processing means 14.

In FIG. 2, the user input receiving means 11 receives an operational input from the user, and the recording schedule information request means 12 transmits a recording schedule information request message 50 to another apparatus. The recording schedule information acquiring means 13 acquires recording schedule information 51 from another apparatus, and the recording schedule information processing means 14 processes the recording schedule information acquired from the other apparatus.

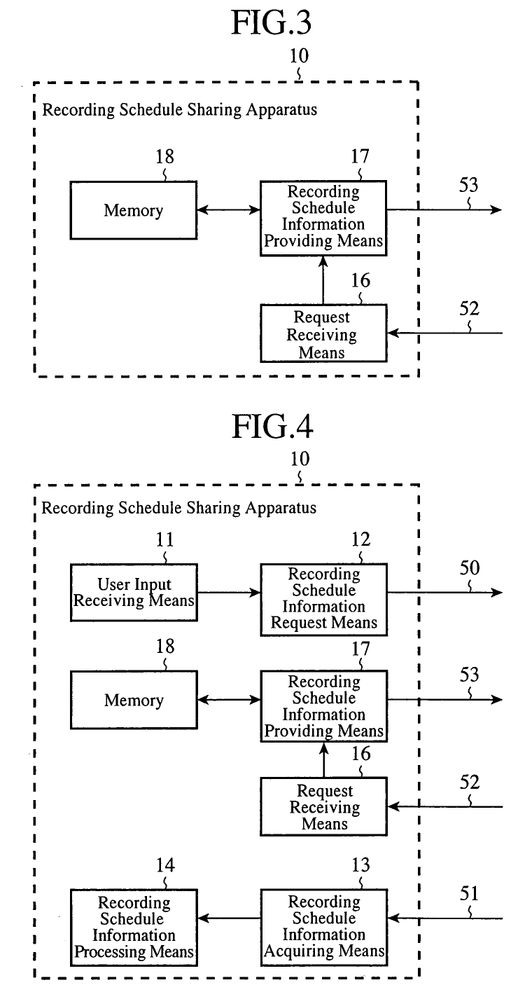

FIG. 3 is a block diagram showing the structure of an information recording schedule sharing apparatus for use in the recording schedule sharing system shown in FIG. 1, which receives a request for recording schedule information from another apparatus, and provides the recording schedule information to the other apparatus, i.e., each of the recording schedule sharing apparatuses 1B and 1C in this Embodiment 1. This recording schedule sharing apparatus 10 is provided with a request receiving means 16, a recording schedule information providing means 17, and a memory 18.

In FIG. 3, the request receiving means 16 receives a recording schedule information request message 52 from another apparatus. The recording schedule information providing means 17 reads the recording schedule information of the apparatus itself stored in the memory 18, and transmits the recording schedule information 53 to another apparatus.

When the user who uses the recording schedule sharing apparatus 1A desires to know the recording schedules of each of the recording schedule sharing apparatuses 1B and 1C which other users, such as the user's friends or acquaintances, use, respectively, the user performs a user operation by using, for example, a remote controller. The user input receiving means 11 of the recording schedule sharing apparatus 10 shown in FIG. 2 then receives this user operation, and instructs the recording schedule information request means 12 to transmit a recording schedule information request message 50.

In contrast, when the request receiving means 16 of the recording schedule sharing apparatus 10 shown in the FIG. 3 which corresponds to each of the recording schedule sharing apparatuses 1B and 1C receives the recording schedule information request message 52 from the recording schedule sharing apparatus 1A, the request receiving means instructs the recording schedule information providing means 17 to read the recording schedule information of the apparatus itself which is stored in the memory 18, and to transmit the recording schedule information 53 to the apparatus which has sent the request to the request receiving means, i.e., the recording schedule sharing apparatus 1A.

When the recording schedule information acquiring means 13 of the recording schedule sharing apparatus 10 shown in the FIG. 2 which corresponds to the recording schedule sharing apparatus 1A receives the recording schedule information 51 from each of the other recording schedule sharing apparatuses 1B and 1C, the recording schedule information processing means 14 processes this recording schedule information, for example, performs a process of searching for another apparatus which can carry out recording of a television broadcast program which the user desires to watch in behalf of the recording schedule sharing apparatus, and presents processed results for the user of the recording schedule sharing apparatus 1A.

As mentioned above, in accordance with this Embodiment 1, by acquiring the recording schedule information from each of the other recording schedule sharing apparatuses 1B and 1C, the recording schedule sharing apparatus 1A enables the user of the recording schedule sharing apparatus 1A to make a request for recording of a program in behalf of the recording schedule sharing apparatus efficiently, and therefore an advantage of being able to improve the convenience of the recording schedule sharing apparatus is provided.

For example, when the user of the recording schedule sharing apparatus 1A is interested in a certain television broadcast program, but he or she cannot record the television broadcast program by himself or herself, the recording schedule sharing apparatus can provide the user with information indicating whether there is any friend or acquaintance who can perform the recording of the broadcast program in behalf of the user, and, if there is a person who can perform the recording of the broadcast program, can provide the user with information indicating who the person is. Therefore, because the possibility that the recording request is refused by other apparatus of which the recording schedule sharing apparatus makes a request for recording of a program in behalf thereof can be reduced, the recording schedule sharing apparatus can make a request for the recording in behalf thereof more efficiently.

In addition, in accordance with this Embodiment 1, because this recording schedule sharing apparatus 10, particularly, a recording schedule sharing apparatus 10 which provides recording schedule information transmits the recording schedule information of the apparatus itself according to a request from another recording schedule sharing apparatus 10, the recording schedule sharing apparatus is not burdened with inquiries about its recording schedule from other users any more, and therefore an advantage of being able to improve the convenience of the apparatus is provided.

For example, when the recording schedule sharing apparatus is going to receive a request for recording of a program in behalf of another user from the other user, because the recording schedule sharing apparatus can provide the recording schedule information to another recording schedule sharing apparatus prior to the reception of the request for the recording in behalf of the other user, the possibility that the recording schedule sharing apparatus refuses the recording request from the request source can be reduced, and therefore the other recording schedule sharing apparatus can make a request for the recording in behalf thereof more efficiently.

In this Embodiment 1, the case in which the number of recording schedule sharing apparatuses 10 which construct the recording schedule sharing system is three is explained, but the number of recording schedule sharing apparatuses is not limited to three and can be alternatively an arbitrary number which is two or more.

Furthermore, this Embodiment 1 is explained assuming that the recording schedule sharing apparatus 1A has a function of acquiring recording schedule information from another apparatus, and each of the recording schedule sharing apparatuses 1B and 1C has a function of providing recording schedule information to another apparatus, but the present embodiment is not limited to this example and an arbitrary combination of recording schedule sharing apparatuses can be provided as long as the condition that at least one of the recording schedule sharing apparatuses 1A, 1B, and 1C which construct the recording schedule sharing system has at least a function of providing recording schedule information to another apparatus and at least one of the recording schedule sharing apparatuses 1A, 1B, and 1C has at least a function of acquiring recording schedule information from another apparatus is satisfied.

Also in the explanation of subsequent embodiments, the number of recording schedule sharing apparatuses which construct a recording schedule sharing system and whether each recording schedule sharing apparatus has a function of acquiring recording schedule information or a function of providing recording schedule information will be described, though these descriptions are only examples for the sake of simplicity. In other words, the condition that at least one of the recording schedule sharing apparatuses which construct the recording schedule sharing system has at least a function of providing recording schedule information to another apparatus and at least one of the recording schedule sharing apparatuses has at least a function of acquiring recording schedule information from another apparatus is the only one which must be satisfied, and this condition is applied to all the subsequent embodiments.

### Embodiment 2

Above-mentioned Embodiment 1 is explained assuming that each of the recording schedule sharing apparatuses 1A, 1B, and 1C for use in the recording schedule sharing system shown in FIG. 1 is

(1) the one which has a function of providing recording schedule information to another apparatus, but does not have a function of acquiring recording schedule information from another apparatus, or

(2) the one which has a function of acquiring recording schedule information from another apparatus, but does not have a function of providing recording schedule information to another apparatus.

However, it cannot be overemphasized that each of the recording schedule sharing apparatuses 1A, 1B, and 1C has both a function of providing recording schedule information to another apparatus, and a function of acquiring recording schedule information from another apparatus.

FIG. 4 is a block diagram showing the structure of a recording schedule sharing apparatus in accordance with Embodiment 2 of the present invention. This recording schedule sharing apparatus 10 is used in a recording schedule sharing system as shown in FIG. 1 and transmits and receives recording schedule information to and from another apparatus, and is provided with a user input receiving means 11, a recording schedule information request means 12, a recording schedule information acquiring means 13, a recording schedule information processing means 14, a request receiving means 16, a recording schedule information providing means 17, and a memory 18.

In FIG. 4, the user input receiving means 11 receives an operational input from a user, and the recording schedule information request means 12 transmits a recording schedule information request message 50 to another apparatus. The recording schedule information acquiring means 13 acquires recording schedule information 51 from another apparatus, and the recording schedule information process means 14 processes the recording schedule information acquired from the other apparatus. The request receiving means 16 receives a recording schedule information request message 52 from another apparatus, and the recording schedule information providing means 17 reads the recording schedule information of the apparatus itself which is stored in the memory 18, and transmits the recording schedule information 53 to another apparatus.

Next, the operation of the recording schedule sharing system will be explained.

In FIG. 4, the operations of the user input receiving means 11, the recording schedule information request means 12, the recording schedule information acquiring means 13, and the recording schedule information processing means 14 are the same as those of the components designated by the same reference numerals in the recording schedule sharing apparatus 10 shown in FIG. 2.

Furthermore, in FIG. 4, the operations of the request receiving means 16, the recording schedule information providing means 17, and the memory 18 are the same those of the components designated by the same reference numerals in the recording schedule sharing apparatus 10 shown in FIG. 3.

When acquiring recording schedule information from another apparatus, each of the recording schedule sharing apparatuses 1A, 1B, and 1C operates in such a manner that the recording schedule information request means 12 transmits a recording schedule information request message 50 to the other apparatus, and the recording schedule information acquiring means 13 receives the recording schedule information 51 from the other apparatus.

In contrast, when providing recording schedule information to another apparatus, each of the recording schedule sharing apparatuses operates in such a manner that the request receiving means 16 receives a recording schedule information request message 52 from the other apparatus, and the recording schedule information providing means 17 reads the recording schedule information of the apparatus itself which is stored in the memory 18 and sends out the recording schedule information 53 to the other apparatus. Therefore, each of the recording schedule sharing apparatuses 1A, 1B, and 1C can serve either a unit which provides recording schedule information to another apparatus or a unit which acquires recording schedule information from another apparatus.

As mentioned above, each recording schedule sharing apparatus in accordance with this Embodiment 2 can make a request for recording of a program in behalf thereof efficiently, and therefore the convenience of each recording schedule sharing apparatus can be improved, as in the case of above-mentioned Embodiment 1. Furthermore, because each of the recording schedule sharing apparatuses 1A, 1B, and 1C which construct the recording schedule sharing system has both a function of providing recording schedule information to another apparatus, and a function of acquiring recording schedule information from another apparatus, there can be provided an advantage of being able to make the recording schedule sharing apparatuses 1A, 1B, and 1C freely share the recording schedule information among them without being restricted by any combination of recording schedule sharing apparatuses.

### Embodiment 3

In the recording schedule sharing system in accordance with above-mentioned Embodiment 1, each of the recording schedule sharing apparatuses 1A, 1B, and 1C which construct the system transmits and receives its recording schedule information directly to and from another apparatus, though the present invention is not limited to this example. As an alternative, each of the recording schedule sharing apparatuses can transmit and receive its recording schedule information to and from another apparatus via a server.

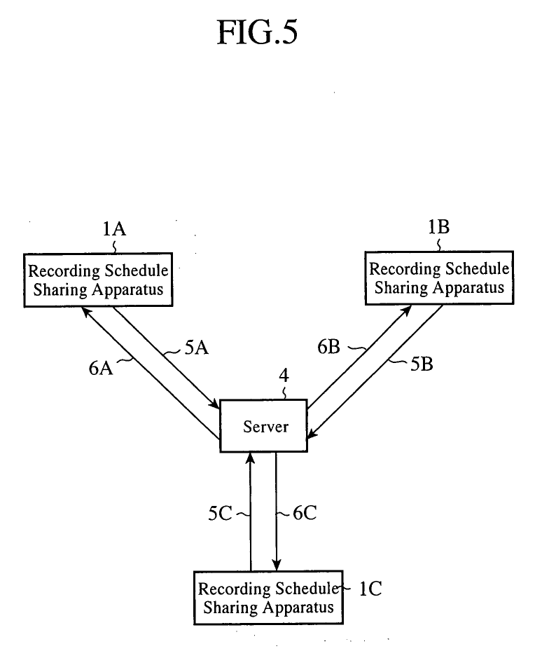

FIG. 5 is a diagram showing the structure of a recording schedule sharing system in accordance with Embodiment 3 of the present invention. In FIG. 5, the recording schedule sharing apparatuses 1A, 1B, and 1C transmit and receive pieces of recording schedule information request messages 5A, 5B, and 5C or pieces of recording schedule information 6A, 6B, and 6C to and from the server 4, respectively. At least one of the recording schedule sharing apparatuses 1A, 1B, and 1C has at least a function of providing recording schedule information to another apparatus, and at least one of the recording schedule sharing apparatuses 1A, 1B, and 1C has at least a function of acquiring recording schedule information from another apparatus.

Next, the operation of the recording schedule sharing system will be explained.

Hereafter, the outline of the operation of this recording schedule sharing system will be explained assuming that the recording schedule sharing apparatus 1A in FIG. 5 has at least a function of acquiring recording schedule information from another apparatus, and each of the recording schedule sharing apparatuses 1B and 1C has at least a function of providing recording schedule information to another apparatus.

For example, when because a user who uses the recording schedule sharing apparatus 1A cannot record a television program, which he or she desires to watch, by himself or herself, the user desires to know the recording schedules of each of the recording schedule sharing apparatuses 1B and 1C of another user, such as the user's friend or acquaintance, the recording schedule sharing apparatus 1A transmits a recording schedule information request message 5A with which the recording schedule sharing apparatus 1A makes a request of the other recording schedule sharing apparatuses 1B and 1C for provision of recording schedule information to the server 4 according to the user's operation. The server 4 delivers the recording schedule information request message 5A which the server has received from the recording schedule sharing apparatus 1A to the recording schedule sharing apparatuses 1B and 1C as recording schedule information request messages 6B and 6C, respectively.

When receiving the recording schedule information request messages 6B and 6C, the other recording schedule sharing apparatuses 1B and 1C transmit pieces of recording schedule information 5B and 5C thereof to the server 4, respectively. The server 4 transfers the pieces of recording schedule information 5B and 5C received from the recording schedule sharing apparatuses 1B and 1C, respectively, to the recording schedule sharing apparatus 1A as recording schedule information 6A.

The user of the recording schedule sharing apparatus 1A thus gets to know the acquired recording schedule information of each of the other recording schedule sharing apparatuses 1B and 1C, and, by using this information, the user can make a request for recording of, for example, a television program which he or she desires to watch in behalf of the user.

As mentioned above, each recording schedule sharing apparatus in accordance with this Embodiment 3 can make a request for recording of a program in behalf thereof efficiently, and therefore the convenience of each recording schedule sharing apparatus can be improved, as in the case of above-mentioned Embodiment 1. Furthermore, because recording schedule information it transmits and received via the server 4, the number of recording schedule information request messages which are sent out from the recording schedule sharing apparatus 1A can be set to one, and this message can be delivered from the server 4 to each of the other recording schedule sharing apparatuses 1B and 1C. Therefore, there can be provided an advantage of being able to reduce the number of messages which the recording schedule sharing apparatus 1A processes, and therefore to reduce the load on the network.

In this Embodiment 3, the server 4 simply transfers the pieces of recording schedule information 5B and 5C received from the recording schedule sharing apparatuses 1B and 1C, respectively, as recording schedule information 6A, to the recording schedule sharing apparatus 1A, as mentioned above. As an alternative, the server 4 combines the pieces of recording schedule information 5B and 5C received from the recording schedule sharing apparatuses 1B and 1C, respectively, into one message, and transfers this message to the recording schedule sharing apparatus 1A as the recording schedule information 6A. By thus combining the pieces of recording schedule information into one message, the present embodiment offers an advantage of being able to further reduce the number of messages which the recording schedule sharing apparatus 1A processes, and therefore to reduce the load.

### Embodiment 4

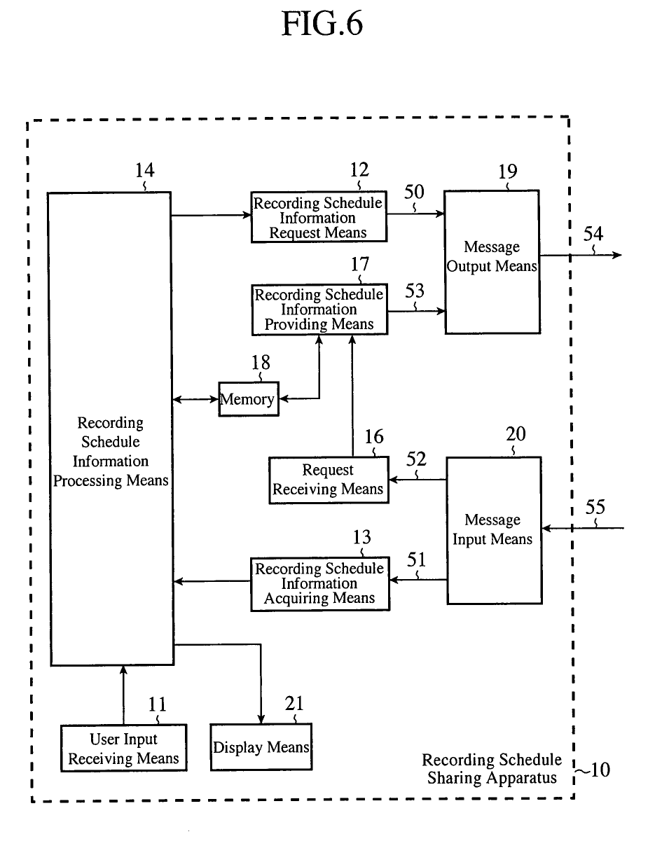

FIG. 6 is a block diagram showing the structure of a recording schedule sharing apparatus in accordance with Embodiment 4 of the present invention. The recording schedule sharing apparatus 10 which transmits and receives recording schedule information to and from another apparatus is provided with a user input receiving means 11, a recording schedule information request means 12, a recording schedule information acquiring means 13, a recording schedule information processing means 14, a request receiving means 16, a recording schedule information providing means 17, a memory 18, a message output means 19, a message input means 20, and a display means 21.

In FIG. 6, the user input receiving means 11 receives an operational input from a user. The recording schedule information request means 12 outputs a recording schedule information request message 50 to another apparatus. The recording schedule information acquiring means 13 acquires recording schedule information 51 from the other apparatus. The recording schedule information processing means 14 carries out an operation of processing the recording schedule information acquired from the other apparatus, and so on. The request receiving means 16 receives a recording schedule information request message 52 from another apparatus. The recording schedule information providing means 17 reads the recording schedule information of the apparatus itself which is stored in the memory 18, and outputs the recording schedule information 53 to the other apparatus. The message output means 19 transmits a message 54 to another apparatus. The message input means 20 receives a message 55 from another apparatus. The display means 21 displays various pieces of information for the user.

In this Embodiment 4, assume that the recording schedule sharing apparatus 10 shown in FIG. 6 is used as each of the recording schedule sharing apparatuses 1A, 1B, and 1C in a recording schedule sharing system as shown in FIG. 1 of above-mentioned Embodiment 1.

Next, the operation of the recording schedule sharing system will be explained.

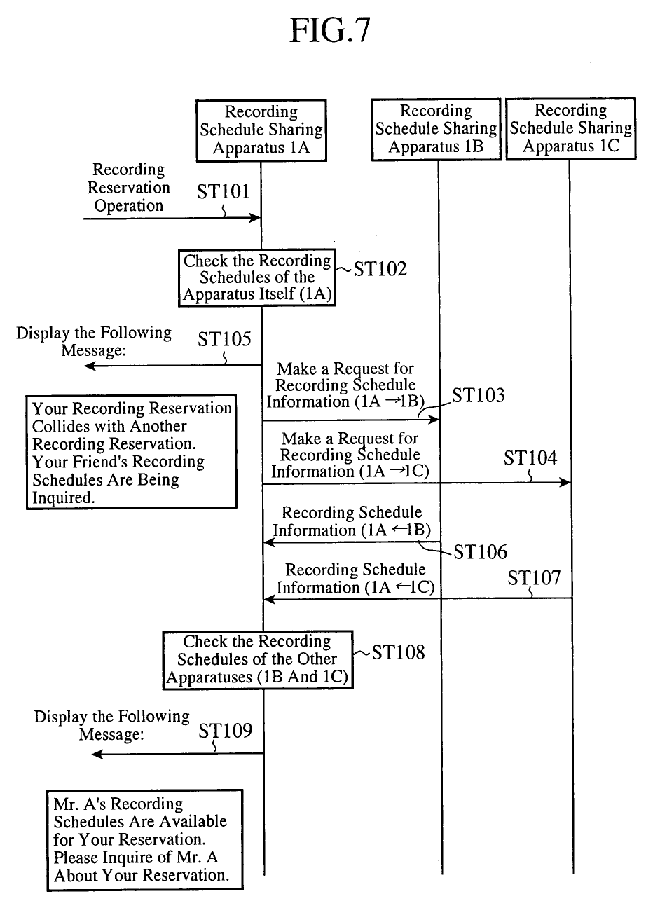

FIG. 7 is a sequence diagram for explaining the operation of each of the recording schedule sharing apparatuses 1A, 1B, and 1C in accordance with Embodiment 4 of the present invention.

When, in step ST101, a user who uses the recording schedule sharing apparatus 1A performs a recording reservation operation by using a remote controller or the like in order to, for example, schedule to record a television broadcast program which he or she desires to watch, the user input receiving means 11 of FIG. 6 receives this recording reservation operation by the user, and notifies the recording reservation to the recording schedule information processing means 14. In step ST102, the recording schedule information processing means 14 refers to the recording schedule information of the apparatus itself which is stored in the memory 18 and checks to see whether the recording schedule information processing means can receive the recording reservation which the user desires to make. When the recording schedule information processing means can receive the recording reservation which the user desires to make, the recording schedule information processing means 14 additionally writes some pieces of information about the new recording reservation which the user desires to make, for example, the date, channel, title and so on of the program into the memory 18, and then ends the processing.

In contrast, when the new recording reservation which the user desires to make cannot be accomplished by the apparatus itself (i.e., in this case, the recording schedule sharing apparatus 1A) for the reason that, for example, the new recording reservation collides with another recoding reservation already-made, the recording schedule information processing means 14 instructs the recording schedule information request means 12 to transmit a recording schedule information request message 50 indicating a request for provision of recording schedule information to each of the recording schedule sharing apparatuses 1B and 1C.

The message output means 19, in steps ST103 and ST104, formats the recording schedule information request message 50 into one in the form of, for example, an e-mail having a predetermined format (a recording schedule information request mail) and transmits this message 54 to each of the recording schedule sharing apparatuses 1B and 1C which the user's friends, acquaintances or the like who are pre-registered thereinto own. In this case, assume that the recording schedule sharing apparatuses 1A, 1B, and 1C are connected to the Internet, and specific e-mail addresses are assigned to the apparatuses, respectively. In this case, pieces of information about the apparatuses owned by the user's friends, acquaintances or the like who should be registered beforehand are the e-mail addresses assigned to the apparatuses, respectively.

When the new recording reservation which the user desires to make cannot be accomplished within the apparatus itself (i.e., the recording schedule sharing apparatus 1A), and the recording schedule information processing means 14 then instructs the recording schedule information request means 12 to transmit a recording schedule information request message 50, the recording schedule information processing means 14 instructs the display means 21 to present a message indicating that the recording schedule information processing means is inquiring about the recording schedule information of each of the recording schedule sharing apparatuses 1B and 1C owned by the user's friends, acquaintances, or the like to the user who uses the recording schedule sharing apparatus 1A. In step ST105, the display means 21 displays the message indicating that the recording schedules of the user's friends, acquaintances, or the like are being inquired.

When each of the recording schedule sharing apparatuses 1B and 1C receives the message 55 (i.e., the recording schedule information request mail) from the recording schedule sharing apparatus 1A by using the message input means 20, each of the recording schedule sharing apparatuses interprets this message so as to judge whether the message is a recording schedule information request message 52 or recording schedule information 51, and, when the received message is a recording schedule information request message 52, transfers the message to the request receiving means 16, or, when the received message is recording schedule information 51, transfers the message to the recording schedule information acquiring means 13. In this case, because the received message is a recording schedule information request message 52, each of the recording schedule sharing apparatuses transfers this message to the request receiving means 16. When receiving the recording schedule information request message 52, the request receiving means 16 instructs the recording schedule information providing means 17 to read the recording schedule information of the apparatus itself which is stored in the memory 18 and output the recording schedule information 53.

In steps ST106 and ST107, the message output means 19 of each of the recording schedule sharing apparatuses 1B and 1C formats the recording schedule information 53 into information in the form of, for example, an e-mail having a predetermined format (a recording schedule information mail) and transmits this message 54 to the apparatus which has sent the request, i.e., the recording schedule sharing apparatus 1A. Information including, for example, the date, channel, title, and so on of each program which is scheduled to be recorded can be included in this recording schedule information 53.

When receiving a message 55 (a recording schedule information mail) from each of the recording schedule sharing apparatuses 1B and 1C by using the message input means 20, the recording schedule sharing apparatus 1A transfers this recording schedule information 51 to the recording schedule information acquiring means 13. This recording schedule information is then sent to the recording schedule information processing means 14. In step ST108, the recording schedule information processing means 14 performs a process of checking the recording schedules of each of the recording schedule sharing apparatuses 1B and 1C so as to judge whether the recording reservation which the user who uses the recording schedule sharing apparatus 1A desires to make can be accomplished by each of the other recording schedule sharing apparatuses 1B and 1C, and provides the result of the judgment as a message to the user by using the display means 21. In step ST109, the display means 21 displays a message indicating that the recording schedules of the user's friend, acquaintance, or the like are available for the recording reservation.

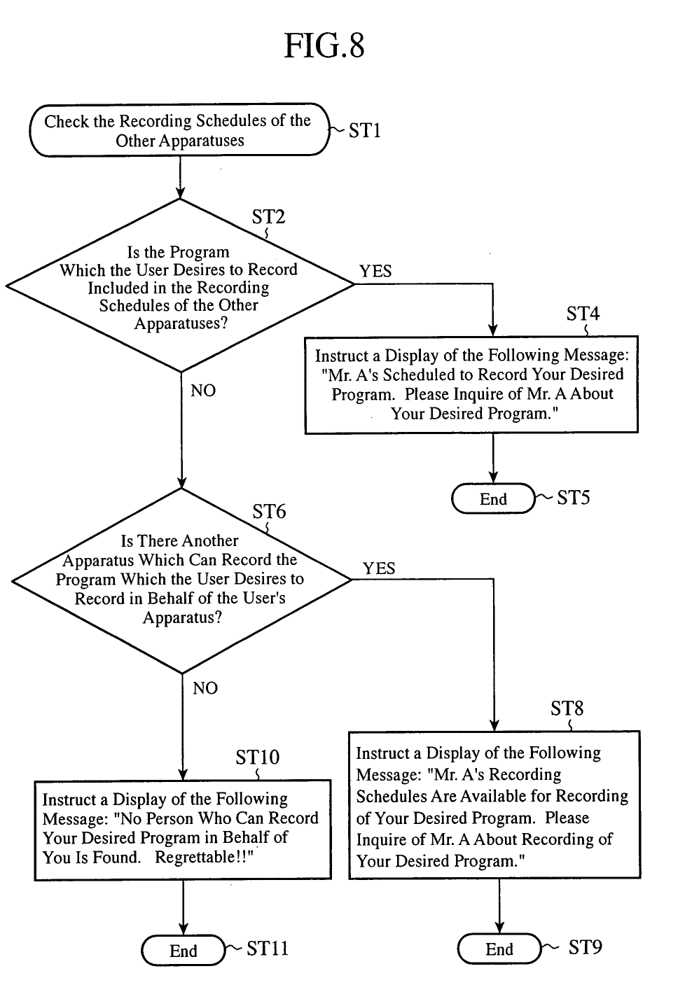

FIG. 8 is a flow chart explaining the process of checking the recording schedules of another apparatus which the recording schedule information processing means 14 performs, and shows a flow of the recording schedule sharing apparatus 1A's process of judging whether a reservation of recording of a program which the user desires can be implemented by each of the other recording schedule sharing apparatuses 1B and 1C on the basis of the recording schedule information of each of the recording schedule sharing apparatuses 1B and 1C, and displaying the judgment result.

When the recording schedule information process means 14, in step ST1, acquires the recording schedule information of another apparatus (each of the recording schedule sharing apparatuses 1B and 1C), the recording schedule information processing means 14, in step ST2, starts the process of checking the recording schedules of each of the other apparatuses and judges whether the recording reservation of the program which the user of the recording schedule sharing apparatus 1A desires the recording schedule sharing apparatus to schedule to record is contained in the recording schedules of each of the other apparatuses.

When the recording reservation of the program which the user desires the recording schedule sharing apparatus to schedule to record is contained in the recording schedules of one of the other apparatuses, the recording schedule information processing means 14, in step ST4, instructs the display means 21 to present information about another apparatus which meets the request (i.e., another apparatus which schedules to record the program) as a message to the user, and, in step ST5, ends the processing. For example, when the owners of all other apparatuses which meet the request (i.e., all other apparatuses which schedule to record the program) are Mr. A and Mr. B, as an example of the message which the display means 21 is instructed to display in step ST4, a message like “Mr. A and Mr. B have scheduled to record the program. Please inquire of Mr. A or Mr. B about the recording.” can be used.

In contrast, when, in above-mentioned step ST2, the recording reservation of the program which the user desires the recording schedule sharing apparatus to schedule to record is not contained in the recording schedules of the other apparatuses, the recording schedule information processing means 14, in step ST6, judges whether or not there is another apparatus (the recording schedule sharing apparatus 1B or 1C) which can record the program which the user of the recording schedule sharing apparatus 1A desires this recording schedule sharing apparatus to schedule to record in behalf of the recording schedule sharing apparatus. In this step ST6, the recording schedule information processing means can judge whether each of the recording schedule sharing apparatuses 1B and 1C can record the program in behalf of the recording schedule sharing apparatus 1A by checking to see whether each of the recording schedule sharing apparatuses 1B and 1C already schedules to record another program at the time zone when the user of the recording schedule sharing apparatus 1A desires the recording schedule sharing apparatus to schedule to record the program.

When there is another apparatus which can record the program which the user desires the recording schedule sharing apparatus to schedule to record in behalf of the recording schedule sharing apparatus, the recording schedule information processing means 14, in step ST8, instructs the display means 21 to present information about another apparatus which meets the request (i.e., another apparatus which can record the program in behalf of the recording schedule sharing apparatus) as a message to the user, and, in step ST9, ends the processing. For example, when the owners of other apparatuses which meet the request are Mr. B and Mr. C, as an example of the message which the display means 21 is instructed to display in step ST8, a message like “The recording schedules of Mr. B and Mr. C are available for your recording reservation. Please inquire of Mr. B or Mr. C about your recording reservation.” can be used.

In contrast, when, in above-mentioned step ST6, there is no other apparatus which can record the program which the user desires the recording schedule sharing apparatus to schedule to record in behalf of the recording schedule sharing apparatus, the recording schedule information processing means 14, in step ST10, instructs the display means 21 to present, as a message, the fact that there is no other apparatus which can record the program in behalf of the recording schedule sharing apparatus to the user, and, in step ST11, ends the processing. In this case, as an example of the message which the display means 21 is instructed to display in step ST10, a message like “Nobody who can record the program in behalf of you is found. Regrettable!!” can be used.

As mentioned above, in accordance with this Embodiment 4, the user input receiving means 11 of a recording schedule sharing apparatus receives a recording reservation operation by a user, and the recording schedule sharing apparatus is then triggered by this recording reservation operation to automatically make a request of each of the other recording schedule sharing apparatuses 1B and 1C for provision of recording schedule information. Therefore, the present embodiment offers an advantage of being able to acquire recording schedule information of other apparatuses without the user performing a special input operation to get to know the recording schedule information of the other apparatuses.

Furthermore, in accordance with this Embodiment 4, when the new recording reservation which the user desires to make cannot be accomplished by the apparatus itself for the reason that, for example, the new recording reservation collides with another recording reservation already made, the recording schedule sharing apparatus transmits a recording schedule information request message to the other recording schedule sharing apparatuses 1B and 1C in order to make a request of the other recording schedule sharing apparatuses 1B and 1C for recording schedule information, so that the user can know of whom he or she should make a request for the recording reservation on the basis of the acquired recording schedules of the other apparatuses. Therefore, the present embodiment offers an advantage of being able to make a request for recording of a program in behalf of a recording schedule sharing apparatus efficiently, and to improve the convenience of the recording schedule sharing apparatus.

In addition, in accordance with this Embodiment 4, while transmitting a recording schedule information request message to the other recording schedule sharing apparatuses 1B and 1C, the recording schedule sharing apparatus 1A presents a message indicating that the recording schedule information of each of the recording schedule sharing apparatuses 1B and 1C owned by the user's friends, acquaintances, or the like is being inquired for the user who uses the recording schedule sharing apparatus 1A. Therefore, the present embodiment offers another advantage of enabling the user to grasp the processing state of the apparatus, and being able to, even when, for example, the time required for another apparatus to return its recording schedule information in response to a request is delayed, prevent the user from feeling uneasy about whether the other apparatus has broken down.

Furthermore, the recording schedule sharing apparatus in accordance with this Embodiment 4 processes the recording schedule information acquired from each of the other recording schedule sharing apparatuses 1B and 1C, judges whether the recording reservation which the user desires to make can be accomplished by each of the other recording schedule sharing apparatuses 1B and 1C, and displays the judgment result as a message for the user. Therefore, the present embodiment offers an advantage of enabling the user to appropriately select a person of whom he or she makes a request for recording of the program which the user desires the recording schedule sharing apparatus to schedule to record in behalf of the user on the basis of the judgment result displayed.

In addition, in accordance with this Embodiment 4, information about the channel and title of each program which is scheduled to be recorded can be included in the recording schedule information. Therefore, the present embodiment offers a further advantage of enabling the user to know whether each of the other recording schedule sharing apparatuses 1B and 1C has already made a recording reservation of the same program as that associated with the new recording reservation which the user desires to make on the basis of the acquired recording schedule information.

Furthermore, in accordance with this Embodiment 4, the message output means 19 formats each of the recording schedule information request message 50 and the recording schedule information 53 to information in the form of an e-mail having a predetermined format, and transmits it. Therefore, the present embodiment offers another advantage of being able to implement sharing of recording schedule information in an environment in which the recording schedule sharing apparatuses 1A, 1B, and 1C are connected to the Internet.

In addition, in accordance with this Embodiment 4, each of the recording schedule sharing apparatuses 1A, 1B, and 1C which construct the recording schedule sharing system are connected to the Internet. Therefore, the present embodiment offers a further advantage of being able to share recording schedule information among the plurality of recording schedule sharing apparatuses 1A, 1B, and 1C which can be arranged at distant places, respectively.

### Embodiment 5

In above-mentioned Embodiment 4, information about the date, channel, and title of each program which is scheduled to be recorded is included in the recording schedule information 53.

As an alternative, no information about the channel and title of each program which is scheduled to be recorded is included in the recording schedule information 53, while only date information about the date of each program which is scheduled to be recorded is included in the recording schedule information.

In above-mentioned Embodiment 4, all the recording schedules of an apparatus itself are provided for the other apparatuses as the recording schedule information 53, as previously explained. As an alternative, some specified recording schedules are not included in the recording schedule information 53 to be provided for other apparatuses. As a result, this embodiment offers an advantage of being able to keep detailed information secret when, for example, the user does not want the details of his or her own recording schedules to be known by others.

### Embodiment 6

In the explanation of above-mentioned Embodiment 4, an example in which transmission and reception of a recording schedule information request message and recording schedule information are carried out using e-mails is explained. The present invention is not limited to this example, and, for example, transmission and reception of the recording schedule information request message and the recording schedule information can be carried out using a telephone.

A block diagram showing the structure of a recording schedule sharing apparatus in accordance with Embodiment 6 of the present invention is the same as that of FIG. 6 of above-mentioned Embodiment 4, though in this Embodiment 6, each of a message output means 19 and a message input means 20 has a function of performing modulation or demodulation by using a modem, instead of the function of transmitting and receiving e-mails.

For example, in a case in which recording schedule sharing apparatuses 1A, 1B, and 1C are not connected to the Internet, but the message output means 19 and the message input means 20 in FIG. 6 are connected to a telephone line via a modem, the message output means 19 of the recording schedule sharing apparatus 1A can modulate a recording schedule information request message 50 from the recording schedule information request means 12 by using the modem, and can transmit, as a message 54, the recording schedule information request message via the telephone line. In this case, information about the apparatuses of the user's friends, acquaintances, and so on, which should be register beforehand, is their telephone numbers.

In contrast, when the message input means 20 of each of the recording schedule sharing apparatuses 1B and 1C receives a message 55 from the recording schedule sharing apparatus 1A, the message input means demodulates this message 55 by using the modem, and interprets the demodulated message so as to judge whether the message is a recording schedule information request message 52 or recording schedule information 51. When the message is a recording schedule information request message 52, the message input means transfers the message to the request receiving means 16, whereas when the message is recording schedule information 51, the message input means transfers the message to the recording schedule information acquiring means 13. In this case, because the message is a recording schedule information request message 52, the message input means 20 transfers this message to the request receiving means 16.

When the request receiving means 16 receives the recording schedule information request message 52, the request receiving means instructs the recording schedule information providing means 17 to provide recording schedule information, so that the recording schedule information providing means 17 reads the recording schedule information of the apparatus itself which is stored in the memory 18 so as to generate recording schedule information 53. The message output means 19 modulates the recording schedule information 53 by using the modem, and transmits this message 54, via the telephone line, to the recording schedule sharing apparatus 1A.

Destination Information about the recording schedule sharing apparatus 1A (the telephone number of this apparatus) which is the destination of the reply can be registered in advance through the user's operation. As an alternative, by transmitting the request message from the recording schedule sharing apparatus 1A with the information about the telephone number of the recording schedule sharing apparatus 1A itself being included in the request message, each of the recording schedule sharing apparatuses 1B and 1C can reply to the message by referring to this information.

The message input means 20 of the recording schedule sharing apparatus 1A demodulates the message 55 from each of the recording schedule sharing apparatuses 1B and 1C by using the modem, so that the recording schedule sharing apparatus 1A can acquire the recording schedule information 51 of each of the other apparatuses (the recording schedule sharing apparatuses 1B and 1C).

As mentioned above, in accordance with this Embodiment 6, the recording schedule sharing apparatuses 1A, 1B, and 1C are connected to the telephone line via their modems, and each of them modulates a recording schedule information request message and recording schedule information using the modem and transmits and receives them via the telephone line. Therefore, the present embodiment offers an advantage of being able to, even when the recording schedule sharing apparatuses 1A, 1B, and 1C cannot be connected to the Internet, enable each of them to make a request for recording of a program in behalf thereof efficiently by sharing the recording schedule information among them, thereby improving the convenience of each of the recording schedule sharing apparatuses.

### Embodiment 7

In the explanation of above-mentioned Embodiment 6, an example in which transmission and reception of recording schedule information are modulated by using a modem and is carried out via a telephone is explained. Even when each recording schedule sharing apparatus does not have a modem, the same functions can be implemented if each recording schedule sharing apparatus can be connected to a telephone line.

A block diagram showing the structure of a recording schedule sharing apparatus in accordance with Embodiment 7 of the present invention is the same as that of FIG. 6 of above-mentioned Embodiment 4, though in this Embodiment 7, each of the message output means 19 and the message input means 20 has a function of coding a message with a DTMF (Dual Tone Multiple Frequency) tone signal or carrying out DTMF decoding, instead of the function of transmitting and receiving e-mails.

For example, in a case in which each of the recording schedule sharing apparatuses 1A, 1B, and 1C does not have a modem, but can be connected to a telephone line, the recording schedule sharing apparatus 1A can code a recording schedule information request message 50 from the recording schedule information request means 12 with a DTMF tone signal and can transmit the recording schedule information request message via the telephone line by using the message output means 19 thereof. In this case, information about the apparatuses of the user's friends, acquaintances, and so on, which should be register beforehand, is their telephone numbers.

In contrast, when the message input means 20 of each of the recording schedule sharing apparatuses 1B and 1C receives a message 55 from the recording schedule sharing apparatus 1A, the message input means performs DTMF decoding on this message 55, and interprets the DTMF-decoded message so as to judge whether the message is a recording schedule information request message 52 or recording schedule information 51. When the message is a recording schedule information request message 52, the message input means transfers the message to the request receiving means 16, whereas when the message is recording schedule information 51, the message input means transfers the message to the recording schedule information acquiring means 13. In this case, because the message is a recording schedule information request message 52, the message input means 20 transfers this message to the request receiving means 16.

When the request receiving means 16 receives the recording schedule information request message 52, the request receiving means instructs the recording schedule information providing means 17 to provide recording schedule information, so that the recording schedule information providing means 17 reads the recording schedule information of the apparatus itself which is stored in the memory 18 so as to generate recording schedule information 53. The message output means 19 codes the recording schedule information 53 with a DTMF signal, and transmits this message 54, via the telephone line, to the recording schedule sharing apparatus 1A.

Destination Information about the recording schedule sharing apparatus 1A (the telephone number of this apparatus) which is the destination of the reply can be registered in advance through the user's operation. As an alternative, by transmitting a DTMF tone signal series with the information about the telephone number of the recording schedule sharing apparatus 1A itself being included in the request message from the recording schedule sharing apparatus 1A, each of the recording schedule sharing apparatuses 1B and 1C can reply to the message by referring to this information.

The message input means 20 of the recording schedule sharing apparatus 1A performs DTMF decoding on the message 55 from each of the recording schedule sharing apparatuses 1B and 1C, so that the recording schedule sharing apparatus 1A can acquire the recording schedule information 51 of each of the other apparatuses (the recording schedule sharing apparatuses 1B and 1C).

As mentioned above, in accordance with this Embodiment 7, each recording schedule sharing apparatus codes a recording schedule information request message and recording schedule information with DTMF tone signals, and transmits and receives them via a telephone line. Therefore, the present embodiment offers an advantage of being able to, even when each of the recording schedule sharing apparatuses 1A, 1B, and 1C does not have a modem, enable each of them to make a request for recording of a program in behalf thereof efficiently by sharing the recording schedule information among them, thereby improving the convenience of each of the recording schedule sharing apparatuses.

### Embodiment 8

The recording schedule sharing apparatus 1A in accordance with above-mentioned Embodiment 4 simply presents information about a person who can perform recording of a program which the user desires the recording schedule sharing apparatus to schedule to record in behalf of the recording schedule sharing apparatus to the user, and the user then needs to actually make a request for the recording by himself or herself by using a telephone or a mail. As an alternative, the recording schedule sharing apparatus 1A can perform a process of making a request for the recording automatically.

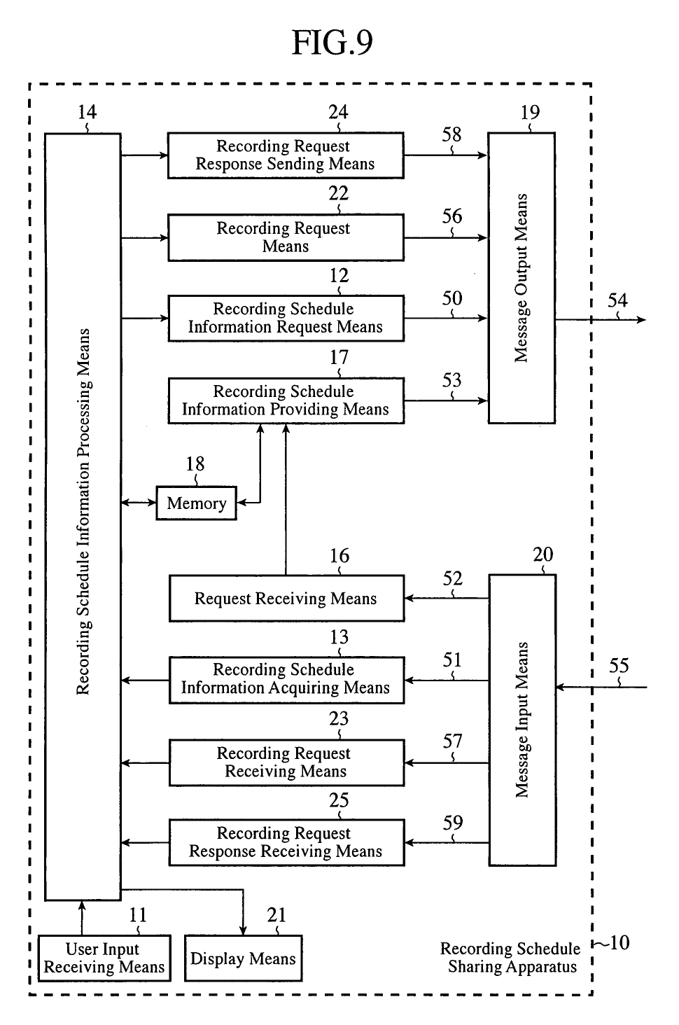

FIG. 9 is a block diagram showing the structure of a recording schedule sharing apparatus in accordance with Embodiment 8 of the present invention. The recording schedule sharing apparatus 10 shown in FIG. 9 additionally includes a recording request means 22, a recording request receiving means 23, a recording request response sending means 24, and a recording request response receiving means 25, in addition to the recording schedule sharing apparatus 10 shown in FIG. 6 of above-mentioned Embodiment 4. In FIG. 9, the other components are the same as those designated by the same reference numerals in the recording schedule sharing apparatus 10 shown in FIG. 6.

In FIG. 9, the recording request means 22 outputs a recording request message 56 to another apparatus. The recording request receiving means 23 receives a recording request message 57 from another apparatus. The recording request response sending means 24 outputs a recording request response message 58 to another apparatus. The recording request response receiving means 25 receives a recording request response message 59 from another apparatus.

In this Embodiment 8, assume that the recording schedule sharing apparatus 10 having the structure of FIG. 9 is used as each of the recording schedule sharing apparatuses 1A, 1B, and 1C in a recording schedule sharing system as shown in FIG. 1.

Next, the operation of the recording schedule sharing system will be explained.

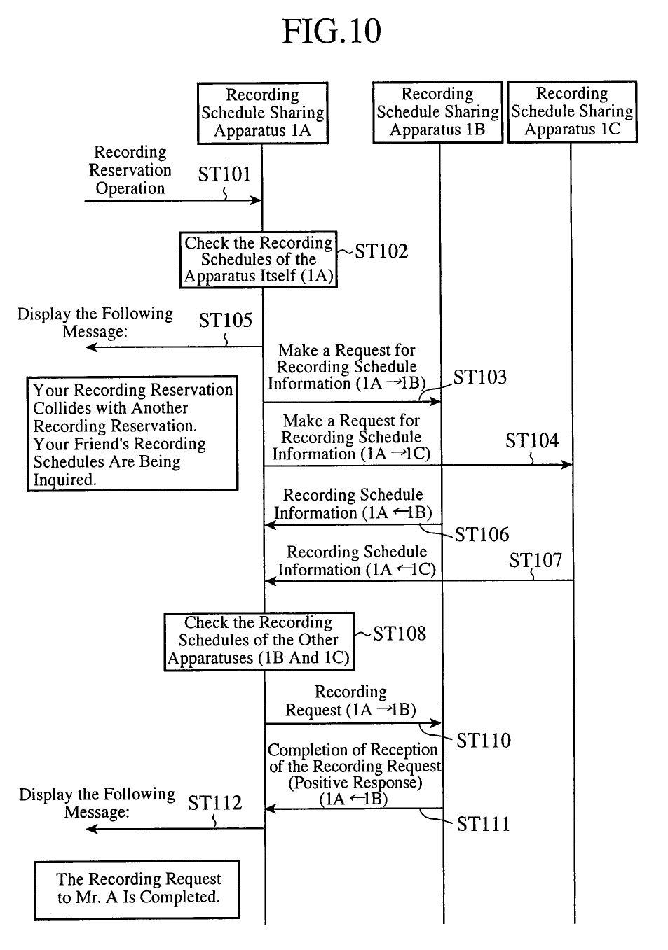

FIG. 10 is a sequence diagram for explaining the operation of each of the recording schedule sharing apparatuses 1A, 1B, and 1C in accordance with Embodiment 8 of the present invention. An operation shown in steps ST101 to ST107 of FIG. 10, that is, an operation of enabling a user who uses the recording schedule sharing apparatus 1A to perform a recording reservation operation using a remote controller or the like, the user input receiving means 11 receiving this recording reservation operation by the user, and the recording schedule sharing apparatus 1A receiving recording schedule information from each of the recording schedule sharing apparatuses 1B and 1C by using the message input means 20 and sending this recording schedule information to the recording schedule information process means 14 is the same as the operation shown in FIG. 7 of above-mentioned Embodiment 4.

In step ST108 of FIG. 10, the recording schedule information processing means 14 performs a process of checking the recording schedules of each of the recording schedule sharing apparatuses 1B and 1C so as to judge whether a recording reservation which the user who uses the recording schedule sharing apparatus 1A desires to make can be accomplished by each of the other recording schedule sharing apparatuses 1B and 1C, and, when there is another apparatus which can accomplish the recording reservation which the user desires to make, instructs the recording request means 22 to transmit a recording request message 56 to the other apparatus which meets the request (e.g., the recording schedule sharing apparatus 1B). Here, the details of the process of checking the recording schedules of the other apparatuses (the recording schedule sharing apparatuses 1B and 1C) which the recording schedule information processing means 14 performs will be explained separately later.

In step ST110, the message output means 19 formats the recording request message 56 into a message in the form of, for example, an e-mail having a predetermined format (a recording request mail) and transmits this message 54 to another apparatus of which the recording schedule sharing apparatus is going to make a request for the recording (e.g., the recording schedule sharing apparatus 1B).

When the other apparatus which is the destination of the recoding request (e.g., the recording schedule sharing apparatus 1B) receives the message 55 (the recording request mail) from the recording schedule sharing apparatus 1A by using the message input means 20, this message input means interprets this message so as to judge the type of the message. In this case, because the message is a recording request message 57, the message input means transfers this message to the recording request receiving means 23. This recording request message is then sent to the recording schedule information processing means 14, and the recording schedule information processing means checks to see whether the requested recording in behalf of the request source can be carried out by the apparatus itself again. Because the recording schedule sharing apparatus 1A has made a request for the recording after getting to know the recording schedules of the other apparatuses (the recording schedule sharing apparatuses 1B and 1C) in advance, the other apparatus in question judges that it can carry out the recording in behalf of the request source as long as there is no special reason. However, when, for example, the user of the other apparatus which is the destination of the recording request does not desire to accept the request for the recording in behalf of the request source, the other apparatus can be allowed to refuse this recording request. For example, there can be considered a use method of refusing this recording request in a case in which the broadcasting time zone of the program which is the target for the recording is a midnight time zone, and the users of the recording schedule sharing apparatuses 1B and 1C do not desire these apparatuses to start the recording operation automatically while they are in bed.

When the recording schedule information processing means 14 judges whether to accept the requested recording reservation in this way, the recording schedule information processing means instructs the recording request response sending means 24 to send out the judgment result as a recording request response message 58. In step ST111, the message output means 19 formats the recording request response message 58 into a message in the form of, for example, an e-mail having a predetermined format (a recording request reception completion mail or a recording request reception rejection mail), and transmits this message 54 to the apparatus which has sent the request, i.e., the recording schedule sharing apparatus 1A. In this case, the recording request reception completion mail is the one which is sent as a positive response in the case of accepting the requested recording reservation, and the recording request denial reception mail is the one which is sent as a negative response in the case of refusing the requested recording reservation.

When the recording schedule sharing apparatus 1A receives the message 55 (the recording request reception completion mail or the recording request reception rejection mail) from another apparatus (for example, the recording schedule sharing apparatus 1B) which is a destination of the recording request by using the message input means 20, the message input means transfers this recording request response message 59 to the recording request response receiving means 25. This recording request response message 59 is then transferred to the recording schedule information processing means 14, and this recording schedule information processing means instructs the display means 21 to display an appropriate message according to whether the received response is a positive response or a negative response for the user. In step ST112, the display means 21 displays the message. For example, when the received response is a positive response, as the message displayed for the user, a message like “Recording request to Mr. OO is completed.” is used, whereas when the received response is a negative response, as the message displayed for the user, a message like “Recording request has been made of Mr. OO, but is refused.” is used.

Next, the details of the process of checking the recording schedules of another apparatus which is performed by the recording schedule information processing means 14 will be explained.

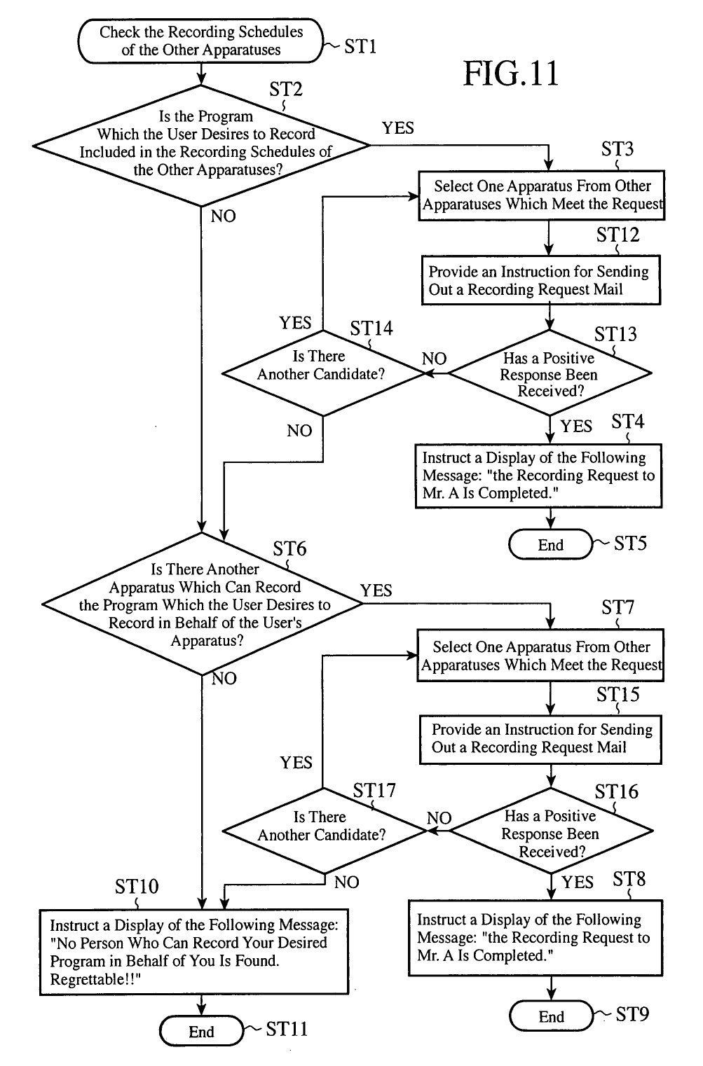

FIG. 11 is a flow chart for explaining the process of checking the recording schedules of another apparatus which is performed by the recording schedule information processing means 14, and shows a flow of the recording schedule sharing apparatus 1A's process of judging whether a reservation of recording of a program which the user desires to record can be accomplished by each of the other recording schedule sharing apparatuses 1B and 1C on the basis of the recording schedule information of each of the recording schedule sharing apparatuses 1B and 1C, and making a request for the recoding on the basis of the judgment result.

When, in step ST1, acquiring the recording schedule information of each of the other apparatuses (the recording schedule sharing apparatuses 1B and 1C), the recording schedule information processing means 14 starts the process of checking the recording schedules of each of the other apparatuses. The recording schedule information processing means 14 then, in step ST2, judges whether the recording reservation of the program which the user of the recording schedule sharing apparatus 1A desires the recording schedule sharing apparatus to schedule to record is contained in the recording schedules of the other apparatuses (the recording schedule sharing apparatuses 1B and 1C).

When the program which the user to desires the recording schedule sharing apparatus to schedule to record is contained in the recording schedules of the other apparatuses, the recording schedule information processing means 14, in step ST3, selects one recording schedule sharing apparatus from other recording schedule sharing apparatuses which meet the request (i.e., other apparatuses which have scheduled to record the program). In step ST12, the recording schedule information processing means 14 instructs the recording request means 22 to send out a recording request mail to the selected other apparatus. In step ST13, the recording schedule information processing means 14 waits for a response from the apparatus which is the destination of this recording request mail. When then receiving a positive response (a recording request reception completion mail) from the apparatus which is the destination of the request, the recording schedule information processing means 14, in step ST4, instructs the display means 21 to display a message indicating that the recording request process has been completed normally, and, in step ST5, ends the processing. For example, when the owner of the other apparatus selected in step ST3 is Mr. A, as an example of the message which the display means 21 is instructed to display in step ST4, a message like “Recording request to Mr. A has been completed.” is used.

In contrast, when, in above-mentioned step ST13, a positive response (a recording request reception completion mail) to the recording request mail is not received from the apparatus which is the destination of the recoding request, for example, when the apparatus which is the destination of the recoding request has refused the reception of the recording request or when any response is not received from the apparatus which is the destination of the recording request after a lapse of a predetermined time interval and a timeout occurs, the recording schedule information processing means 14, in step ST14, judges whether or not there is another candidate which has scheduled to record the program which the user desires to record. When another candidate is found in step ST14, the recording schedule information processing means 14 returns to above-mentioned step ST3 in which the recording schedule information processing means 14 selects one apparatus from above-mentioned other apparatuses which meet the request (i.e., other candidates), and performs the same processing hereafter. When no other candidates are found in step ST14, the recording schedule information processing means shifts to the process of step ST6.

In contrast, when, in the judgment of above-mentioned step ST2, the program which the user desires the recording schedule sharing apparatus to schedule to record is not contained in the recording schedules of the other apparatuses (the recording schedule sharing apparatuses 1B and 1C), or when, in the judgment of the above-mentioned step ST14, there is no other candidate apparatus of which the recording schedule sharing system makes a request for the recording, the recording schedule information processing means 14, in step ST6, judges whether or the program which the user of the recording schedule sharing apparatus 1A desires the recording schedule sharing apparatus to schedule to record can be recorded in behalf of the recording schedule sharing apparatus 1A by another apparatus (each of the recording schedule sharing apparatuses 1B and 1C). In this step ST6, the recording schedule information processing means can judge whether each of the recording schedule sharing apparatuses 1B and 1C can record the program in behalf of the recording schedule sharing apparatus 1A by checking to see whether each of the recording schedule sharing apparatuses 1B and 1C already schedules to record another program at the time zone when the user of the recording schedule sharing apparatus 1A desires the recording schedule sharing apparatus to schedule to record the program.

When there are other apparatuses (the recording schedule sharing apparatuses 1B and 1C) can record the program which the user desires the recording schedule sharing apparatus to schedule to record in behalf of the recording schedule sharing apparatus, the recording schedule information processing means 14, in step ST7, selects one apparatus from the other apparatuses which meet the request (i.e., other apparatuses which are able to schedule to record the program), the recording schedule information processing means 14, in step ST15, instructs the recording request means 22 to send out a recording request mail to the selected other apparatus. The recording schedule information processing means 14 then, in step ST16, waits for a response to this recording request mail from the apparatus which is the destination of the recording request. When then receiving a positive response (a recording request reception completion mail) from the apparatus which is the destination of the recording request, the recording schedule information processing means 14, in step ST8, instructs the display means 21 to display a message indicating that the recording request process has been completed normally, and, in step ST9, ends the processing. For example, when the owner of the other apparatus selected in above-mentioned step ST7 is Mr. B, as an example of the message which the display means 21 is instructed to display in this step ST8, a message like “Recording quest to Mr. B has been completed.” is used.

In contrast, when, in above-mentioned step ST16, a positive response (a recording request reception completion mail) to the recording request mail is not received from the apparatus which is the destination of the recoding request, for example, when the apparatus which is the destination of the recoding request has refused the reception of the recording request or when any response is not received from the apparatus which is the destination of the recording request after a lapse of a predetermined time interval and a timeout occurs, the recording schedule information processing means 14, in step ST17, judges whether or not there is another candidate which can record the program which the user desires to record in behalf of the recording schedule sharing apparatus. When another candidate is found in step ST17, the recording schedule information processing means 14 returns to above-mentioned step ST7 in which the recording schedule information processing means 14 selects one apparatus from above-mentioned other apparatuses which meet the request (i.e., other candidates), and performs the same processing hereafter. When no other candidates are found in step ST17, the recording schedule information processing means shifts to the process of step ST10.

In contrast, when, in the judgment of above-mentioned step ST6, there are no other apparatuses (no other recording schedule sharing apparatuses 1B and 1C) which can record the program which the user desires the recording schedule sharing apparatus to schedule to record in behalf of the recording schedule sharing apparatus, or when, in the judgment of above-mentioned step ST17, there are no candidate apparatuses of which the recording schedule sharing apparatus makes a request for the recording, the recording schedule information processing means 14, in step ST10, instructs the display means 21 to display, as a message, the fact that there is no apparatus which can record the program in behalf of the recording schedule sharing apparatus for the user, and, in step ST11, ends the processing. In this case, as an example of the message which the display means 21 is instructed to display in step ST10, a message like “Nobody who can record the program in behalf of you is found. Regrettable!!” can be used.

As mentioned above, each recording schedule sharing apparatus in accordance with this Embodiment 8 can make a request for recording of a program in behalf thereof efficiently, and therefore the convenience of each recording schedule sharing apparatus can be improved, as in the case of above-mentioned Embodiment 1. Furthermore, because each recording schedule sharing apparatus not only displays information about a person who can carry out recording of the program which the user desires each recording schedule sharing apparatus to schedule to record, but also performs a process of making a request for the recording automatically, the present embodiment offers an advantage of being able to eliminate the necessity for the user to handle a recording request to other apparatuses, and to further improve the convenience of each recording schedule sharing apparatus.

In addition, in accordance with this Embodiment 8, because the user of an apparatus which is the destination of the recording request is enabled to refuse the recording request, another advantage of being able to prevent an operation of recording the program from being started at a time zone which the user of the apparatus which is the destination of the recording request does not desire, for example, at a midnight time zone is provided.

As previously explained, each recording schedule sharing apparatus does not display any message for the user until either a positive response or a negative response is received from another apparatus which is the destination of the request after each recording schedule sharing apparatus has made a request of the other apparatus for the recording. As an alternative, a message indicating that a recording schedule sharing apparatus is making a request of another apparatus for recording of a program can be displayed for the user after the recording schedule sharing apparatus has made a request of the other apparatus for the recording. For example, in this case, as the message displayed for the user, a message like “Recording request to Mr. OO is being made.” can be used. Therefore, in the case in which each recording schedule sharing apparatus does in this way, the present embodiment offers another advantage of enabling the user to grasp the processing state of the apparatus which the user uses, and being able to, even when, for example, the time required for another apparatus to return either a positive response or a negative response in response to the recording request is delayed, prevent the user from feeling uneasy about whether the other apparatus has broken down.

### Embodiment 9

In above-mentioned Embodiment 8, there can be considered a problem that after the recording schedule sharing apparatus 1A has made a request of the recording schedule sharing apparatus 1B for recording of a program, if the user of the recording schedule sharing apparatus 1B adds recording reservations in the apparatus itself, the free space of the disk of the recording schedule sharing apparatus 1B decreases and therefore it will become impossible for the recording schedule sharing apparatus 1B to accomplish any recording reservation which the user of the recording schedule sharing apparatus 1B is newly going to add because of insufficient available hard disk space.

As a solution when such a problem arises, there can be considered, for example, a method of making a request of the other recording schedule sharing apparatuses 1A and 1C to make a recording reservation which the user of the recording schedule sharing apparatus 1B is going to add in behalf of the recording schedule sharing apparatus 1B.

However, when the above-mentioned solution is implemented, a recording reservation which can be made essentially by the recording schedule sharing apparatus 1B will be requested of another apparatus, and therefore there arises a problem that the number of times that a recording request is made between users increases more than necessary. As a solution of this problem, there can be considered a method of giving priority to recording reservations being made in an apparatus itself, temporarily cancelling a recording request made by any other apparatus, and rearranging the recording schedules of the apparatus by searching for another apparatus which can carry out the recording in behalf of the apparatus.

A block diagram showing the structure of a recording schedule sharing apparatus in accordance with Embodiment 9 of the present invention is the same as that shown in FIG. 9 of above-mentioned Embodiment 8.

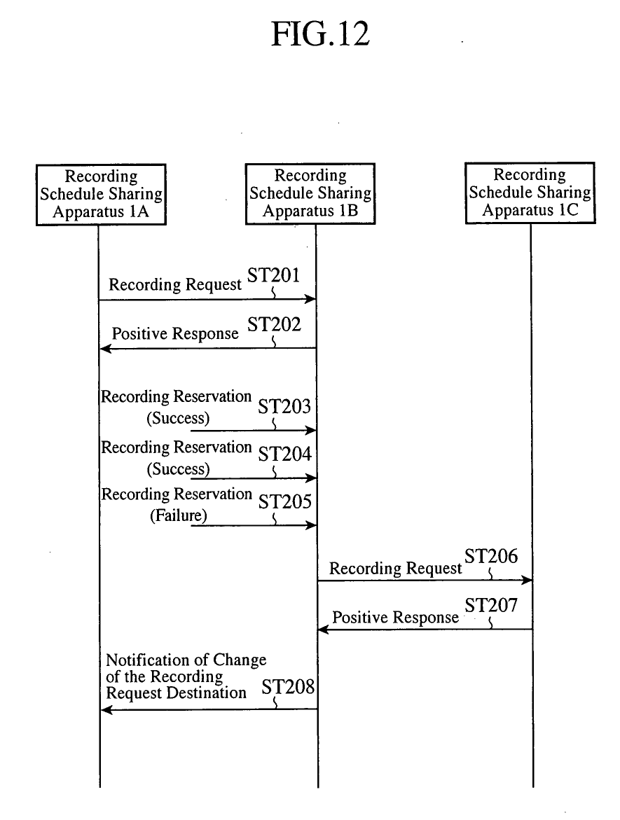

FIG. 12 is a sequence diagram for explaining an operation of rearranging recording schedules in a recording schedule sharing system in accordance with Embodiment 9 of the present invention.

In step ST201, the recording schedule sharing apparatus 1A makes a request of the recording schedule sharing apparatus 1B for recording of a program, and, after the recording schedule sharing apparatus 1B acknowledges in step ST202, the recording schedule sharing apparatus 1B, in steps ST203, ST204, and ST205, tries to make recording reservations 3 times in succession therewithin. However, in this case, a status in which the recording schedule sharing apparatus cannot make the third-time recording reservation of step ST205 because of insufficient available hard disk space occurs.

In this case, in step ST206, the recording schedule information request means 12 of the recording schedule sharing apparatus 1B searches for another recording schedule sharing apparatus which can accomplish the recording reservation which has been requested thereof by the recording schedule sharing apparatus 1A according to an instruction from the recording schedule information processing means 14, and the recording request means 22 of the recording schedule sharing apparatus 1B makes a request of the other apparatus which can accomplish the recording reservation and which has been searched for (in this case, the recording schedule sharing apparatus 1C) for the recording of the program which the user of the recording schedule sharing apparatus 1A originally desires to record in behalf of the recording schedule sharing apparatus according to an instruction from the recording schedule information processing means 14. When the recording request response receiving means 25 of the recording schedule sharing apparatus 1B, in step ST207, receives a positive response from the recording schedule sharing apparatus 1C, the recording request response sending means 24 of the recording schedule sharing apparatus 1B, in step ST208, notifies the fact that the destination of the request of the recording of the program which the user of the recording schedule sharing apparatus 1A originally desires to record has been changed from the recording schedule sharing apparatus 1B to the recording schedule sharing apparatus 1C to the recording request response receiving means 25 of the recording schedule sharing apparatus 1A according to an instruction from the recording schedule information processing means 14, and the operation of rearranging the recording schedules is then completed.

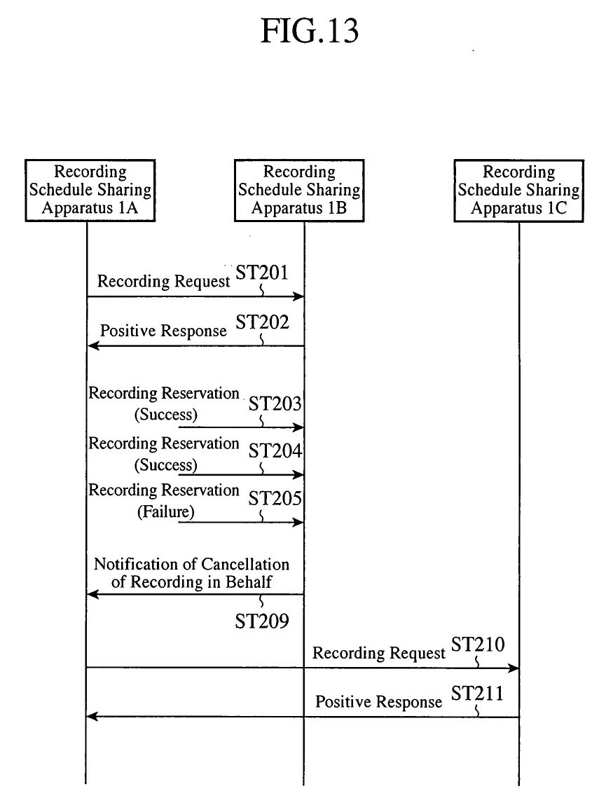

FIG. 13 is a sequence diagram explaining another operation of rearranging recording schedules in the recording schedule sharing system in accordance with Embodiment 9 of the present invention.

The operation in steps ST201 to ST205 is the same as that of FIG. 12. The recording request response sending means 24 of the recording schedule sharing apparatus 1B, in step ST209, notifies cancellation of the recording reservation which has been requested by the recording schedule sharing apparatus 1A to the recording request response receiving means 25 of the recording schedule sharing apparatus 1A according to an instruction from the recording schedule information processing means 14, the recording schedule sharing apparatus 1A, in step ST210, receives this notification of cancellation, the recording schedule information request means 12 searches for another recording schedule sharing apparatus which can accomplish the canceled recording reservation according to an instruction from the recording schedule information processing means 14, and the recording request means 22 makes a request of the searched for other apparatus which can accomplish the recording reservation (in this case, the recording schedule sharing apparatus 1C) for the recording in behalf of the recording schedule sharing apparatus again according to an instruction from the recording schedule information processing means 14. When the recording request response receiving means 25 of the recording schedule sharing apparatus 1A, in step ST211, receives a positive response from the recording schedule sharing apparatus 1C, the operation of rearranging the recording schedules is ended.

As mentioned above, in accordance with this Embodiment 9, each recording schedule sharing apparatus is provided with a function of reallocating a recording request. Therefore, the present embodiment offers an advantage of being able to, when a user who has received a recording request adds a reservation of the recording to an apparatus thereof, and this results in lack of the free disk space, remove the lack of the free disk space without increasing the number of times that a recording request is made between users more than necessary.

### Embodiment 10

In above-mentioned Embodiment 8, a selection criterion at the time (in steps ST3 and ST7 of FIG. 11) of, when there are two or more candidates of which a recording request can be made, selecting one apparatus from the other apparatuses which meet the request is not explained in particular, though there can be considered, for example, a method of the recording request means 22 making a recording request of an apparatus with the largest free disk space among pieces of apparatus capability information about the other apparatuses according to an instruction from the recording schedule information processing means 14. In this case, as a mechanism for notifying the free disk space, for example, a method of including information about the disk free space in the recording schedule information which is to be transmitted from each of the recording schedule sharing apparatuses 1B and 1C to the recording schedule sharing apparatus 1A can be used.

As mentioned above, in accordance with this Embodiment 10, because when there are two or more candidates of which a recording schedule sharing apparatus can make a recording request, the recording schedule sharing apparatus makes a recording request of an apparatus with the largest free disk space among the two or more apparatuses, an advantage of being able to prevent each of the free disk spaces of the plurality of recording schedule sharing apparatuses which construct the recording schedule sharing system from biasedly increasing or decreasing can be provided.

### Embodiment 11

In the explanation of above-mentioned Embodiment 10, as for a selection criterion at the time (in steps ST3 and ST7 of FIG. 11) of, when there are two or more candidates of which a recording request can be made, selecting one apparatus from the other apparatuses which meet the request, a method of making a recording request of an apparatus with the largest free disk space among the other apparatuses is explained. However, the present invention is not limited to this example, and, for example, the recording request means 22 can select another apparatus which can carry out the recording with the highest image quality among pieces of apparatus capability information about the other apparatuses which can carry out the recording in behalf of the recording schedule sharing apparatus according to an instruction from the recording schedule information processing means 14.

In this case, as a mechanism for notifying information about image quality with which the program can be recorded, for example, a method of including information about the capabilities of the recording schedule sharing apparatuses 1B and 1C into the pieces of recording schedule information which are to be transmitted from the recording schedule sharing apparatuses 1B and 1C to the recording schedule sharing apparatus 1A respectively can be used. As an alternative, the information about the capability of each recording schedule sharing apparatus can be notified separately from the recording schedule information.

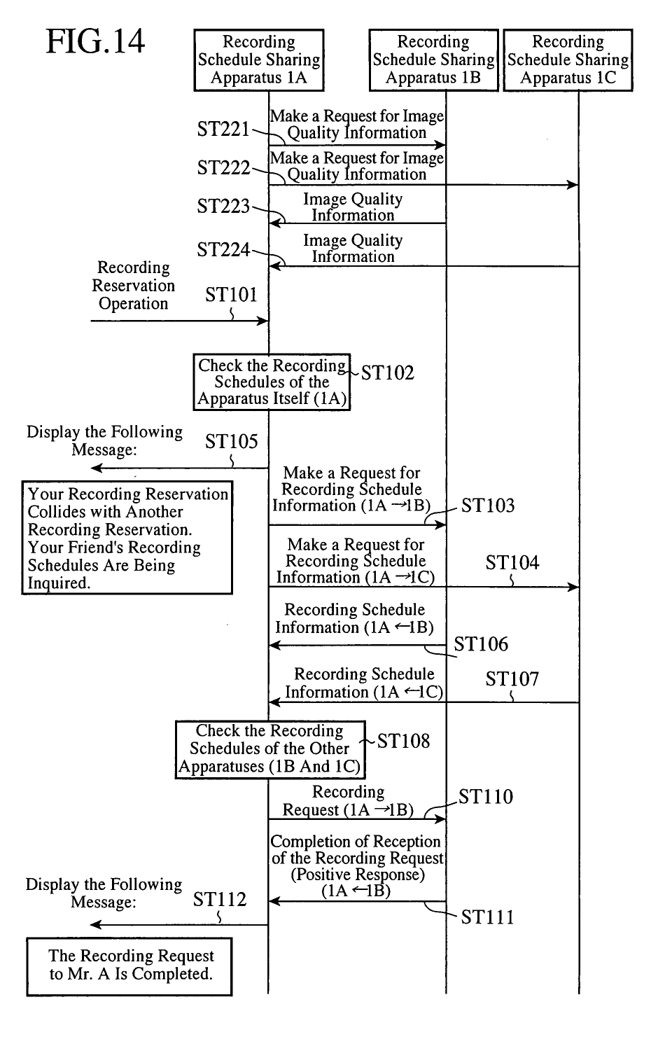

FIG. 14 is a sequence diagram for explaining an operation of notifying the information about the capability of each recording schedule sharing apparatus separately from the recording schedule information in a recording schedule sharing system in accordance with Embodiment 11 of the present invention.

The recording schedule information request means 12 of the recording schedule sharing apparatus 1A, in steps ST221 and ST222, sends out a message indicating that the recording schedule sharing apparatus makes a request of each of the other apparatuses (the recording schedule sharing apparatuses 1B and 1C) for provision of image quality information, and the recording schedule information providing means 17 of each of the other apparatuses (the recording schedule sharing apparatuses 1B and 1C), in steps ST223 and ST224, sends out a message indicating that each of the other apparatuses has provided the image quality information about the other apparatus itself to the recording schedule sharing apparatus 1A. As the description of this image quality information, for example, a resolution, a frame rate, a bit rate, an encoding algorithm, or the like can be included. As an alternative, as the description of the image quality information, for example, information about a profile and a level of MPEG-2 can be transmitted.

After that, the user of the recording schedule sharing apparatus 1A, in step ST101, performs a recording reservation operation, and the recording schedule information processing means 14 of the recording schedule sharing apparatus 1A, in step ST102, checks whether the recording schedule sharing apparatus can accept the recording reservation which the user desires to make with reference to the recording schedule information of the apparatus itself from the memory 18. When the recording schedule sharing apparatus cannot accomplish the recording reservation therewithin, the recording schedule information process means 14 of the recording schedule sharing apparatus 1A, in steps ST103 and ST104, transmits a recording schedule information request message, via the recording schedule information request means 12, to each of the other apparatuses (the recording schedule sharing apparatuses 1B and 1C), and, in step ST105, displays a message for the user via the display means 21. The recording schedule information processing means 14 of the recording schedule sharing apparatus 1A then, in steps ST106 and ST107, acquires a recording schedule information message from each of the other apparatuses (the recording schedule sharing apparatuses 1B and 1C) via the recording schedule information acquiring means 13.

The recording schedule information processing means 14 of the recording schedule sharing apparatus 1A, in step ST108, checks the recording schedules of each of the other apparatuses (the recording schedule sharing apparatuses 1B and 1C), and checks to see whether or not there are other apparatuses which can carry out the recording which the user desires the recording schedule sharing apparatus to carry out. When there are two or more other apparatuses which can carry out the recording which the user desires the recording schedule sharing apparatus to carry out, the recording schedule information processing means 14 of the recording schedule sharing apparatus 1A, in step ST110, selects an apparatus which can carry out the recording with the highest image quality, and the recording request means 22 makes a request of the apparatus (in this case, the recording schedule sharing apparatus 1B) for the recording. When the recording schedule information processing means 14 of the recording schedule sharing apparatus 1A, in step ST111, receives a completion of reception of the recording request (a positive response) from the recording schedule sharing apparatus 1B via the recording request response receiving means 25, the recording schedule information processing means, in step ST112, displays a message for the user via the display means 21.

As mentioned above, each recording schedule sharing apparatus in accordance with this Embodiment 11, when there are two or more candidates of which each recording schedule sharing apparatus makes a request for recording of a program, selects an apparatus which can record the program with the highest image quality. Therefore, an advantage of being able to provide recording quality with a high degree of satisfaction for the user who has made the recording request.

### Embodiment 12

In the explanation of above-mentioned Embodiment 11, as for a selection criterion at the time (in steps ST3 and ST7 of FIG. 11) of, when there are two or more candidates of which a request for recording of a program can be made, selecting one apparatus from the other apparatuses which meet the request, a method of making a recording request of an apparatus which can record the program with the highest image quality among the other apparatuses is explained. When a display used for the user to view and listen to a video in the apparatus which is the source of the recording request has a low quality, for example, when the display has a low resolution, recording with a resolution higher than the resolution of this display has much futility. Therefore, in such a case, it is preferable to select, for example, an apparatus which can record the program with an image quality suitable for the quality of the display which the user uses to view and listen to the program, among pieces of apparatus capability information about the other apparatuses which can record the program in behalf of the recording schedule sharing apparatus.

As mentioned above, each recording schedule sharing apparatus in accordance with this Embodiment 12, when there are two or more candidates of which each recording schedule sharing apparatus makes a request for recording of a program, selects an apparatus which can record the program with an image quality suitable for the quality of the display which the user uses to view and listen to the program. Therefore, the present embodiment offers an advantage of being able to allocate a recording reservation which is to be accomplished by an apparatus which can record a program with a high quality to recording for the users of apparatuses which need high image quality as much as possible, and hence to efficiently allocate the capabilities of the recording schedule sharing apparatuses which construct the recording schedule sharing system, thereby being able to carry out the recording in behalf of a recording schedule sharing apparatus without futility.

### Embodiment 13

In above-mentioned Embodiment 10, Embodiment 11, and Embodiment 12, when there are two or more candidates of which a recording request can be made and one apparatus is selected from the two or more other apparatuses which meet the request (in steps ST3 and ST7 of FIG. 11), an apparatus which is the destination of the recording request is selected automatically on the basis of either the free disk space or the image quality information of the apparatus. The present invention is not limited to this example. As an alternative, the candidates for the destination of the recording request can be shown for the user so that the user can select an apparatus which is the destination of the recording request.

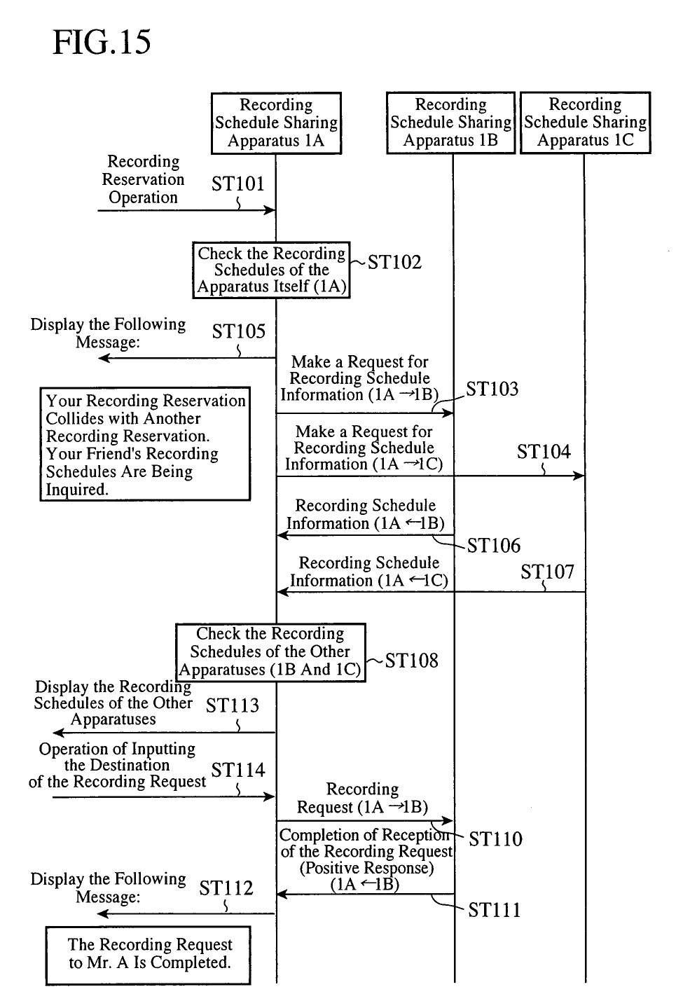

FIG. 15 is a sequence diagram for explaining an operation of showing candidates for the destination of the recording request for the user, and enabling the user to select an apparatus which is the destination of the recording request in a recording schedule sharing system in accordance with Embodiment 13 of the present invention.

In FIG. 15, processing starting from a recording reservation operation by the user of the recording schedule sharing apparatus 1A in step ST101, and ending at reception of a recording schedule information mail from each of other apparatuses (recording schedule sharing apparatuses 1B and 1C) by the recording schedule sharing apparatus 1A in steps ST106 and ST107 is the same as that shown in FIG. 10 of above-mentioned Embodiment 8.

A flow of a process of the recording schedule sharing apparatus 1A, in step ST108 of FIG. 15, checking the recording schedules of each of the other apparatuses (the recording schedule sharing apparatuses 1B and 1C) is as shown in FIG. 11 of above-mentioned Embodiment 8. In this Embodiment 13, in a case in which, in steps ST3 and step ST7 of FIG. 11, there are two or more candidates of which the recording request can be made, when one apparatus is selected from the other apparatuses which meet the request, the recording schedule information processing means 14, in step ST113 of FIG. 15, displays the recording schedules of all the other apparatuses which have been selected as the candidates for the user via the display means 21 first so as to urge the user to input the destination of the recording request. When the user determines the destination of the recording request which the user desires, and performs, in step ST114, an operation of inputting the destination of the recording request, the recording schedule information processing means 14, in step ST110, sends out a recording request message to the specified other apparatus (in this case, the recording schedule sharing apparatus 1B) via the recording request means 22. The processes in subsequent steps ST111 and ST112 are the same as those of FIG. 10 of above-mentioned Embodiment 8.

As mentioned above, each recording schedule sharing apparatus in accordance with this Embodiment 13 enables the user to specify the destination of a recording request which the user desires when there are two or more candidates of which the recording request can be made. Therefore, the present embodiment offers an advantage of being able to provide a use of, for example, visiting the house of the user's friend who owns the apparatus which is the destination of the recording request to view the recorded program, thereby improving the convenience of each recording schedule sharing apparatus.

In the above-mentioned explanation, when there are two or more candidates of which the recording request can be made, the recording schedule sharing apparatus shows candidates for the destination of the recording request for the user so as to enable the user to select an apparatus which is the destination of the recording request. As an alternative, the user can input other persons which the user desires beforehand, for example. By doing in this way, the present embodiment offers an advantage of being able to save the user from having to repeatedly specify the destination of the recording request which the user desires, thereby improving the convenience of each recording schedule sharing apparatus.

### Embodiment 14

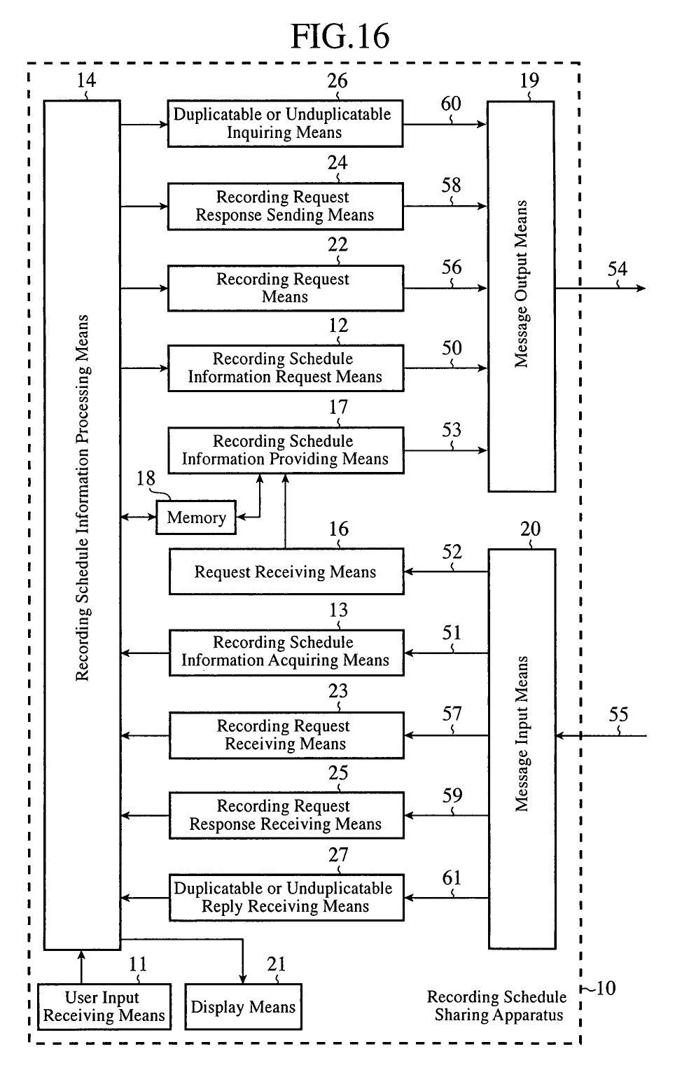

FIG. 16 is a block diagram showing the structure of a recording schedule sharing apparatus in accordance with Embodiment 14 of the present invention. The recording schedule sharing apparatus 10 shown in FIG. 16 additionally includes a duplicatable or unduplicatable inquiring means 26 and a duplicatable or unduplicatable reply receiving means 27 in addition to the recording schedule sharing apparatus 10 shown in FIG. 9 of above-mentioned Embodiment 8, and the other components are the same as those designated by the same reference numerals as those shown in FIG. 9.

Next, the operation of the recording schedule sharing apparatus will be explained.

In FIG. 16, the operations of the user input receiving means 11, the recording schedule information request means 12, the recording schedule information acquiring means 13, the recording schedule information processing means 14, the request receiving means 16, the recording schedule information providing means 17, the memory 18, the message output means 19, the message input means 20, the display means 21, the recording request means 22, the recording request receiving means 23, the recording request response sending means 24, and the recording request response receiving means 25 are the same as those of the components designated by the same reference numerals in the recording schedule sharing apparatus shown in FIG. 9.

The duplicatable or unduplicatable inquiring means 26 has a function of allowing a person who has made a request for recording of a program or who has actually recorded a program which he or she was requested to record to transmit a duplicatable or unduplicatable inquiry message 60 for acquiring approval of duplication of the recorded TV program into a medium, such as a DVD, to the right holder who holds the right of duplication of the program in question. At this time, an instruction from the user is transferred to the duplicatable or unduplicatable inquiring means 26 via the user input receiving means 11 and the recording schedule information processing means 14.

The duplicatable or unduplicatable reply receiving means 27 has a function of receiving a duplicatable or unduplicatable reply message 61 from the right holder who holds the right of duplication of the program in question.

In a case in which duplication of a content that is intended for anything beyond private use is performed, like a case in which a person who has been requested to record a program and has recorded it duplicates the recorded program into a medium, such as a DVD, and hands this medium to another person who has made the request, the recording schedule sharing apparatus provided with such a function can easily inquire of the right holder about whether or not the program can be duplicated, and this is convenient for the user.

In this Embodiment 14, other information about, for example, a credit card number can be included into the duplicatable or unduplicatable inquiry message 60 which the duplicatable or unduplicatable inquiring means 26 transmits, so that the user can make a payment of a fee for purchase of the right of duplication of a content.

Furthermore, the recording schedule sharing apparatus in accordance with this Embodiment 14 can have a function of, in a case in which a recorded content stored in the hard disk of the recording schedule sharing apparatus 10 is copy-protected, and therefore cannot be duplicated into a medium, such as a DVD, having the copy protection released by the right holder by transmitting and receiving a duplicatable or unduplicatable inquiry message 60 and a duplicatable or unduplicatable reply message 61 to and from the right holder.

In addition, the recording schedule sharing apparatus in accordance with this Embodiment 14 is constructed in such a manner as to, by using the duplicatable or unduplicatable reply receiving means 27, receive the duplicatable or unduplicatable reply message 61 which the right holder replies in response to the duplicatable or unduplicatable inquiry message 60 which the duplicatable or unduplicatable inquiring means 26 has transmitted, though there can be considered an example of getting a reply indicating whether or not the content can be duplicated from the right holder by letter. In this variant, the duplicatable or unduplicatable reply receiving means 27 is not necessarily indispensable.

As mentioned above, each recording schedule sharing apparatus in accordance with this Embodiment 14 has the function of transmitting a message for acquiring approval of duplication of a TV program which the user has recorded to the right holder who holds the right of duplication of the program in question. Therefore, the present embodiment offers an advantage of being able to reduce the time and effort for the user to acquire approval duplication of a content, thereby improving the convenience of each recording schedule sharing apparatus.

Furthermore, each recording schedule sharing apparatus in accordance with this Embodiment 14 can have the function of, in a case in which a recorded content is copy-protected and therefore cannot be duplicated into another medium, having the copy protection released by the right holder by transmitting and receiving a duplicatable or unduplicatable inquiry message 60 and a duplicatable or unduplicatable reply message 61 to and from the right holder. Therefore, the present embodiment offers an advantage of being able to reduce the time and effort for the user to acquire approval duplication of a content, thereby improving the convenience of each recording schedule sharing apparatus.

### Embodiment 15

In above-mentioned Embodiment 14, the explanation is made assuming that the process of inquiring about whether a content can be duplicated is not related directly with the process of making a request for recording, but is performed independently. As an alternative, a recording schedule sharing apparatus can make a request for recording of a program by including information about the result of inquiry of whether the program can be duplicated in the recording request message.

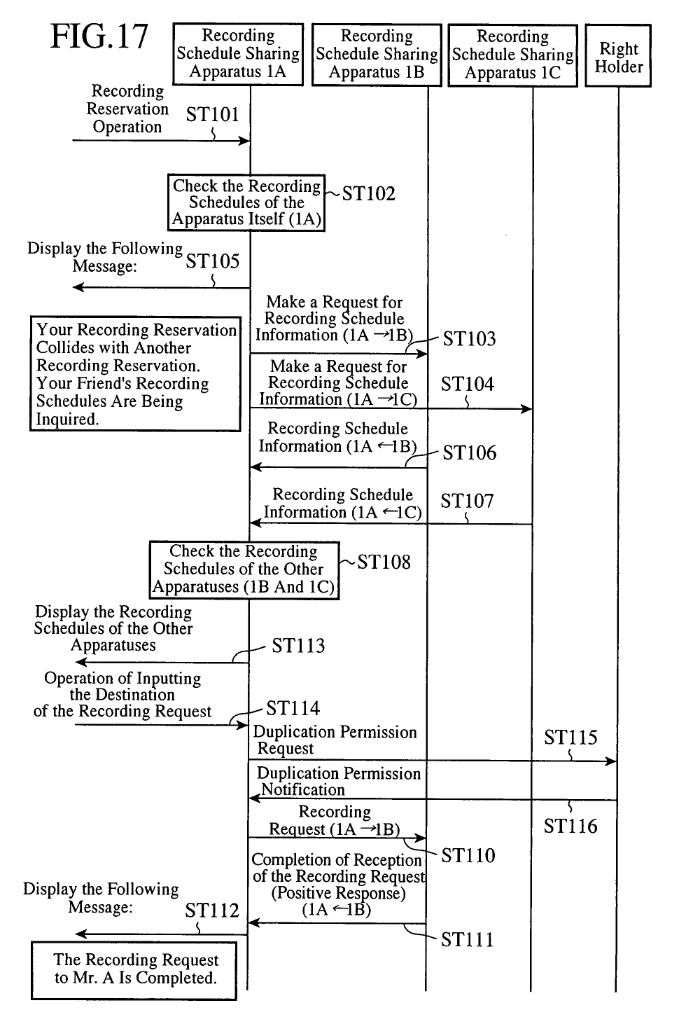

FIG. 17 is a sequence diagram for explaining the operation of a recording schedule sharing system in accordance with Embodiment 15 of the present invention in the case of making a request for recording of a program by including information about the result of inquiry of whether the program can be duplicated in the recording request message.

In FIG. 17, processing starting from a recording reservation operation by the user of the recording schedule sharing apparatus 1A in step ST101, and ending at the user, in step ST114, performing an input operation of inputting a destination of the recording request is the same as that of FIG. 15 of above-mentioned Embodiment 13.

When the user, in step ST114, performs an input operation of inputting a destination of the recording request, the duplicatable or unduplicatable inquiring means 26 of the recording schedule sharing apparatus 1A, in step ST115, transmits a duplicatable or unduplicatable inquiry message 60 for acquiring approval of duplication of a recorded TV program into a medium, such as a DVD, to the right holder who holds the right of duplication of the program in question according to an instruction from the recording schedule information process means 14. At this time, an instruction from the user is transferred to the duplicatable or unduplicatable inquiring means 26 via the user input receiving means 11 and the recording schedule information processing means 14 of FIG. 16.

The recording schedule sharing apparatus 1A then, in step ST116, receives a duplicatable or unduplicatable reply message 61 from the right holder. When acquiring permission of duplication of the program from the right holder, the recording schedule sharing apparatus 1A, in step ST110, makes a request of the destination of the recording request (the recording schedule sharing apparatus 1B) for recording of the program. At this time, the duplicatable or unduplicatable reply receiving means 27 of FIG. 16 transfers the duplicatable or unduplicatable reply message 61 which it has received to the recording schedule information processing means 14, and the recording schedule information processing means 14 instructs the recording request means 22 to make a request for the recording of the program. Information indicating that permission of duplication of the recorded program has been acquired from the right holder is included in the message of this recording request. When the recording schedule information processing means 14 of the recording schedule sharing apparatus 1A, in step ST111, receives a recording request reception completion message (a positive response), via the recording request response receiving means 25, from the recording schedule sharing apparatus 1B, the recording schedule information processing means, in step ST112, displays a message indicating that the recording request has been completed for the user via the display means 21.

As mentioned above, each recording schedule sharing apparatus in accordance with this Embodiment 15 makes a request for recording of a program by including information about the result of inquiry of whether the program can be duplicated in the recording request message. Therefore, the present embodiment offers an advantage of being able to enable a user who has been requested to record a program to take on the task of recording the program in behalf of another user who has made a request of the user for the recording without worrying about whether duplication of the program has been permitted, thereby improving the convenience of each recording schedule sharing apparatus.

In this Embodiment 15, the explanation is made assuming that the user of a recording schedule sharing apparatus selects a destination of a recording request, though this embodiment can also be applied to a case in which the recording schedule sharing apparatus selects the destination of the request automatically.

### Embodiment 16

Every time when a recording schedule sharing apparatus in accordance with above-mentioned Embodiment 4 needs to make a request of another apparatus for recording of a program, the recording schedule sharing apparatus inquires of the other apparatus about information about the recording schedules of the other apparatus. As an alternative, recording schedule information acquired from other apparatuses can be stored in a memory, and, when the recording schedule sharing apparatus needs to get to know information about the recording schedules of another apparatus the next time, the recording schedule sharing apparatus can refer to the recording schedule information stored in the memory thereof without inquiring of the other apparatus about the recording schedules of the other apparatus.

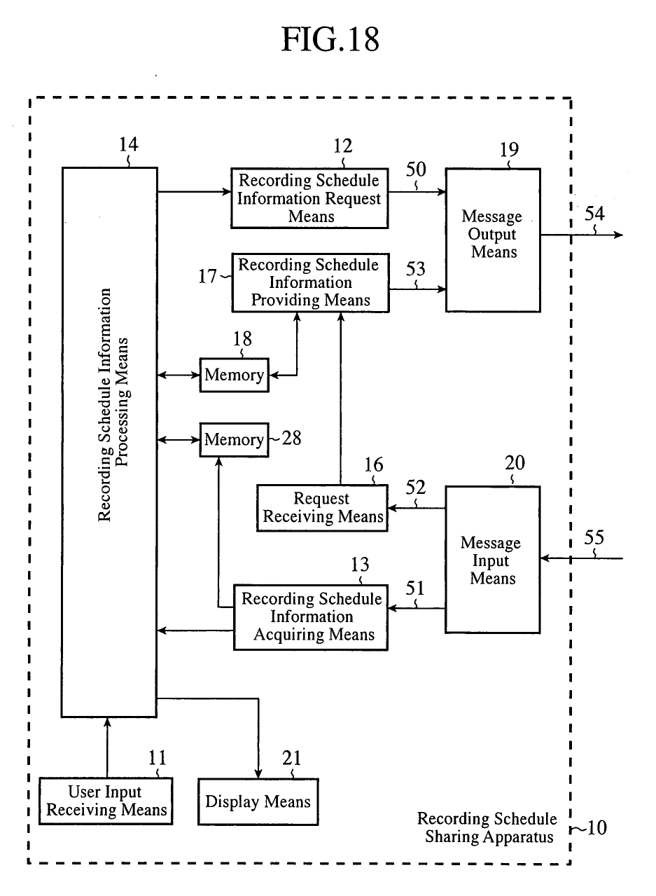

FIG. 18 is a block diagram showing the structure of a recording schedule sharing apparatus in accordance with Embodiment 16 of the present invention. The recording schedule sharing apparatus 10 shown in FIG. 18 additionally includes a memory 28 for storing information about the recording schedules of other apparatuses in addition to the recording schedule sharing apparatus 10 shown in FIG. 6 of above-mentioned Embodiment 4, and the other components are the same as those designated by the same reference numerals as those shown in FIG. 6.

Next, the operation of a recording schedule sharing system will be explained.

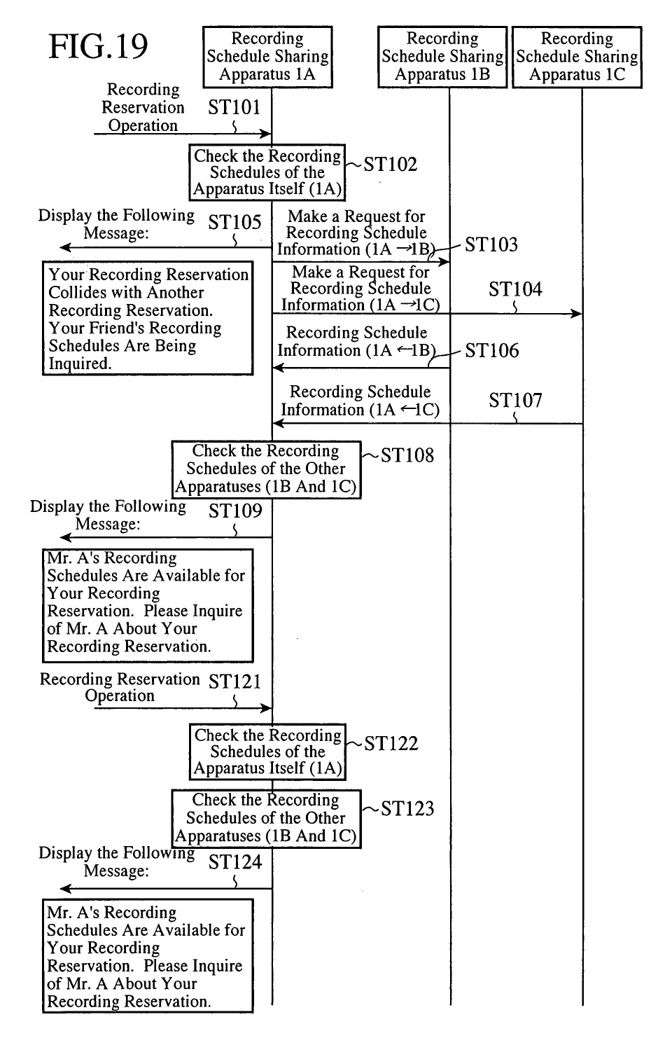

FIG. 19 is a sequence diagram showing the operation of the recording schedule sharing system in accordance with Embodiment 16 of the present invention.

When the user of the recording schedule sharing apparatus 1A, in step ST101, performs a recording reservation operation for the first time, the recording schedule information processing means 14 of the recording schedule sharing apparatus 1A, in step ST102, checks the recording schedules of the apparatus itself from the memory 18. As a result, when the recording schedule sharing apparatus judges that it cannot accomplish the recording reservation therewithin for the reason that, for example, the recording reservation collides with another recoding reservation already-made, the recording schedule information process means 14 of the recording schedule sharing apparatus 1A, in steps ST103 and ST104, makes a request of the other apparatuses (the recording schedule sharing apparatuses 1B and 1C) for provision of the recording schedule information, via the recording schedule information request means 12, and, in step ST105, displays a message for the user via the display means 21. When the recording schedule information processing means 14 of the recording schedule sharing apparatus 1A, in steps ST106 and ST107, receives the recording schedule information, via the recording schedule information acquiring means 13, from each of the other apparatuses (the recording schedule sharing apparatuses 1B and 1C), the recording schedule information processing means 14 of the recording schedule sharing apparatus 1A, in step ST108, checks the recording schedules of each of the other apparatuses (the recording schedule sharing apparatuses 1B and 1C), and, in step ST109, displays a message about other apparatuses which can record the program in behalf of the recording schedule sharing apparatus for the user via display means 21.

When the recording schedule information processing means 14 of the recording schedule sharing apparatus 1A receives the recording schedule information, via the recording schedule information acquiring means 13, from each of the other apparatuses (the recording schedule sharing apparatuses 1B and 1C), the recording schedule information processing means also stores the recording schedule information acquired by the recording schedule information acquiring means 13 in the memory 28.

When the user then, in step ST121, performs a recording reservation operation for the second time, the recording schedule information processing means 14 of the recording schedule sharing apparatus 1A, in step ST122, checks the recording schedules of the apparatus itself from the memory 18, and, when the recording schedule sharing apparatus judges that it cannot accomplish the recording reservation which the user desires the recording schedule sharing apparatus to make therewithin for the reason that, for example, the recording reservation collides with another recoding reservation already-made, the recording schedule information processing means 14 of the recording schedule sharing apparatus 1A, in step ST123, reads the recording schedule information of each of the other apparatuses (the recording schedule sharing apparatuses 1B and 1C) which has been stored in the memory 28 and checks the recording schedules of each of the other apparatuses without making a request of each of the other apparatuses (the recording schedule sharing apparatuses 1B and 1C) for provision of the recording schedule information, and, in step ST124, displays a message about other apparatuses which can record the program in behalf of the recording schedule sharing apparatus for the user.

As mentioned above, each recording schedule sharing apparatus in accordance with this Embodiment 16, when there is necessity to get to know the recording schedules of other apparatuses, refers to the recording schedule information of each of other apparatuses which has been stored therein on a priority basis. Therefore, the present embodiment offers an advantage of being able to reduce the number of messages which are transmitted among apparatuses.

### Embodiment 17

A recording schedule sharing apparatus in accordance with above-mentioned Embodiment 4 receives a recording reservation operation by using the user input receiving means 11, and shares only the recording schedule information with other apparatuses, as previously explained. As an alternative, the recording schedule sharing apparatus can receive not only a recording reservation operation but an input operation of inputting a viewing-and-listening schedule by using the user input receiving means 11, can share both the recording schedule information and the viewing-and-listening schedule information with other apparatuses, and, on the basis of these pieces of information, can display information about another apparatus of which the recording schedule sharing apparatus will make a request for recording for the user.

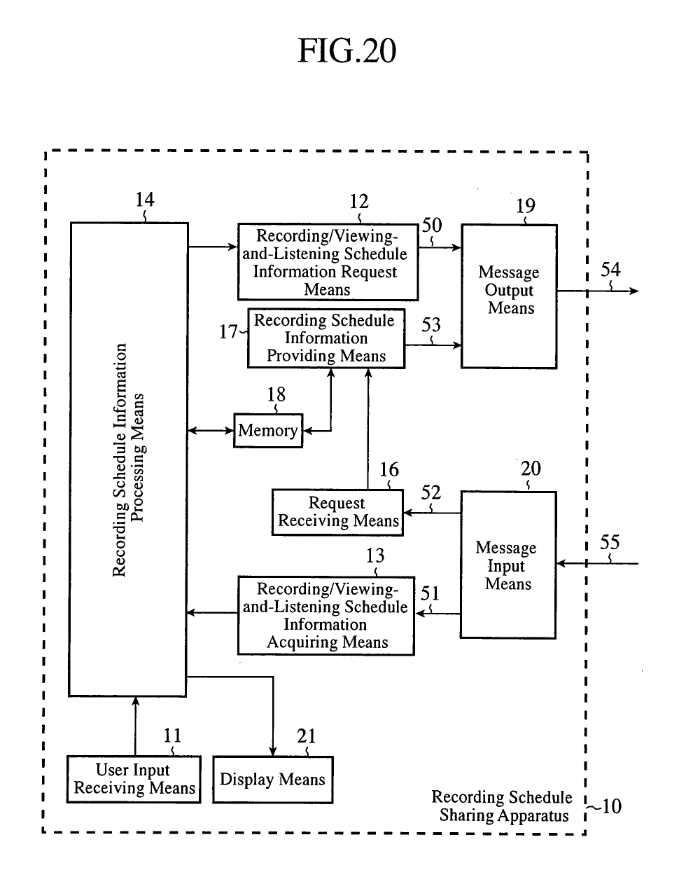

FIG. 20 is a block diagram showing the structure of the recording schedule sharing apparatus in accordance with Embodiment 17 of the present invention. In the recording schedule sharing apparatus 10 shown in FIG. 20, the recording schedule information request means 12, the recording schedule information acquiring means 13, the recording schedule information processing means 14, and the recording schedule information providing means 17 of the recording schedule sharing apparatus 10 shown in FIG. 6 of above-mentioned Embodiment 4 are replaced by a recording/viewing-and-listening schedule information request means 12, a recording/viewing-and-listening schedule information acquiring means 13, a recording/viewing-and-listening schedule information processing means 14, and a recording/viewing-and-listening schedule information providing means 17, respectively, and the other components are the same as those designated by the same reference numerals shown in FIG. 6.

In FIG. 20, the user input receiving means 11 receives an operational input from a user. The user input receiving means receives not only the user's recording reservation operation but an input operation specifying a viewing-and-listening schedule. The recording/viewing-and-listening schedule information request means 12 outputs a recording/viewing-and-listening schedule information request message 50 to another apparatus, and the recording/viewing-and-listening schedule information acquiring means 13 acquires recording/viewing-and-listening schedule information 51 from the other apparatus. The recording/viewing-and-listening schedule information processing means 14 performs an operation of processing the recording/viewing-and-listening schedule information acquired from the other apparatus, and so on, the request receiving means 16 receives a recording/viewing-and-listening schedule information request message 52 from another apparatus, the recording/viewing-and-listening schedule information providing means 17 provides recording/viewing-and-listening schedule information 53 to the other apparatus, and the memory 18 stores the recording/viewing-and-listening schedule information of the apparatus itself.

The recording schedule sharing apparatus 10 shown in FIG. 20 differs from the recording schedule sharing apparatus 10 shown in FIG. 6 of above-mentioned Embodiment 4 in the following five points.

(1) The user input receiving means 11 receives not only a user's recording reservation operation but an input operation specifying a viewing-and-listening schedule.

(2) The recording/viewing-and-listening schedule information request means 12 and the request receiving means 16 transmit and receive not only a message indicating a request for provision of recording schedule information but a message indicating a request for provision of viewing-and-listening schedule information, respectively.

(3) The recording/viewing-and-listening schedule information providing means 17 and the recording/viewing-and-listening schedule information acquiring means 13 transmit and receive not only the recording schedule information but the viewing-and-listening schedule information, respectively.

(4) The memory 18 stores not only the recording schedule information but the viewing-and-listening schedule information.

(5) The recording/viewing-and-listening schedule information processing means 14 performs an operation of processing not only the recording schedule information but the viewing-and-listening schedule information.

Next, the operation of each recording schedule sharing apparatus will be explained.

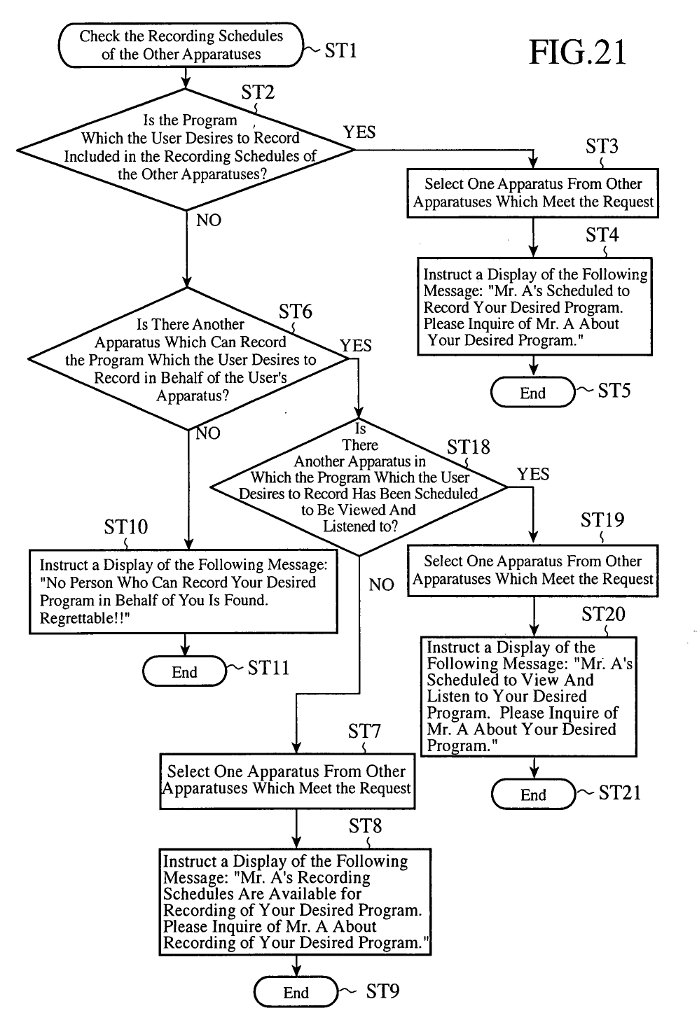

FIG. 21 is a flow chart explaining a process of checking the recording schedules and the viewing-and-listening schedules of another apparatus which the recording/viewing-and-listening schedule information process means 14 performs, and shows a flow of a process of a recording schedule sharing apparatus 1A judging whether a desired recording reservation can be accomplished by each of other recording schedule sharing apparatuses 1B and 1C on the basis of the recording schedule information and the viewing-and-listening schedule information of each of the recording schedule sharing apparatuses 1B and 1C, and displaying the judgment result.

When, in step ST1, receiving the recording/viewing-and-listening schedule information of each of the other apparatuses (the recording schedule sharing apparatuses 1B and 1C), the recording/viewing-and-listening schedule information processing means 14 starts the process of checking the recording schedules and the viewing-and-listening schedules of each of the other apparatuses. The recording/viewing-and-listening schedule information processing means 14 then, in step ST2, judges whether the recording reservation of the program which the user of the recording schedule sharing apparatus 1A desires the recording schedule sharing apparatus to schedule to record is contained in the recording schedules of the other apparatuses (the recording schedule sharing apparatuses 1B and 1C).

When the recording reservation of the program which the user to desires the recording schedule sharing apparatus to schedule to record is contained in the recording schedules of the other apparatuses, the recording/viewing-and-listening schedule information processing means 14, in step ST3, selects one recording schedule sharing apparatus from other recording schedule sharing apparatuses which meet the request (i.e., apparatuses which have scheduled to record the program). The recording/viewing-and-listening schedule information processing means 14 then, in step ST4, instructs the display means 21 to display, as a message, the information about the selected other apparatus for the user, and, in step ST5, ends the processing.

In contrast, when, in above-mentioned step ST2, the recording reservation of the program which the user desires the recording schedule sharing apparatus to schedule to record is not contained in the recording schedules of the other apparatuses (the recording schedule sharing apparatuses 1B or 1C), the recording/viewing-and-listening schedule information processing means 14, in step ST6, judges whether each of the other apparatuses can record the program which the user of the recording schedule sharing apparatus 1A desires this recording schedule sharing apparatus to schedule to record in behalf of the recording schedule sharing apparatus. In this step ST6, the recording/viewing-and-listening schedule information processing means can judge whether each of the recording schedule sharing apparatuses 1B and 1C can record the program in behalf of the recording schedule sharing apparatus 1A by checking to see whether each of the recording schedule sharing apparatuses 1B and 1C already schedules to record another program at the time zone when the user of the recording schedule sharing apparatus 1A desires the recording schedule sharing apparatus to schedule to record the program.

When there is another apparatus (either or both of the recording schedule sharing apparatuses 1B and 1C) which can record the program which the user desires the recording schedule sharing apparatus to schedule to record in behalf of the recording schedule sharing apparatus, the recording/viewing-and-listening schedule information processing means 14, in step ST18, judges whether or not the program which the user of the recording schedule sharing apparatus 1A desires the recording schedule sharing apparatus to schedule to record is included in the viewing-and-listening schedules of each of the other apparatuses.

When the program which the user desires the recording schedule sharing apparatus to schedule to record is contained in the viewing-and-listening schedules of one or more of the other apparatuses (the recording schedule sharing apparatuses 1B and 1C), the recording/viewing-and-listening schedule information processing means 14, in step ST19, selects one apparatus from other apparatuses which meet the request (i.e., apparatuses which have scheduled to provide the program for a user's viewing and listening). The recording/viewing-and-listening schedule information processing means 14 then, in step ST20, instructs the display means 21 to display, as a message, information about the selected other apparatus for the user, and, in step ST21, ends the processing. For example, when the user of the other apparatus selected in step ST19 is Mr. B, as an example of the message which the display means 21 is instructed to display in step ST20, a message like “Mr. B has scheduled to view and listen to the program. Please inquire of Mr. B about the viewing and listening.” can be used.

In contrast, when, in above-mentioned step ST18, there is no other apparatus which has scheduled to provide the program which the user desires the recording schedule sharing apparatus to schedule to record for a user's viewing and listening (neither of the recording schedule sharing apparatuses 1B and 1C has scheduled to provide the program for a user's viewing and listening), the recording/viewing-and-listening schedule information processing means 14, in step ST7, selects one apparatus from other apparatuses which meet the request (i.e., other apparatuses which can record the program in behalf of the recording schedule sharing apparatus). The recording/viewing-and-listening schedule information processing means 14 then, in step ST8, instructs the display means 21 to display, as a message, information about the selected other apparatus for the user, and, in step ST9, ends the processing.

In contrast, when, in above-mentioned step ST6, there is no other apparatus which can record the program which the user desires the recording schedule sharing apparatus to schedule to record in behalf of the recording schedule sharing apparatus (neither of the recording schedule sharing apparatuses 1B and 1C can record the program), the recording/viewing-and-listening schedule information processing means 14, in step ST10, instructs the display means 21 to display, as a message, the fact that there is no apparatus which can record the program in behalf of the recording schedule sharing apparatus for the user, and, in step ST11, ends the processing.

As mentioned above, each recording schedule sharing apparatus in accordance with this Embodiment 17 shares both the recording schedule information and the viewing-and-listening schedule information with other apparatuses, and, on the basis of these pieces of information, displays information about another apparatus of which each recording schedule sharing apparatus will make a request for recording of a program for the user. Therefore, for a user of whom another recording schedule sharing apparatus has made a request for recording of a program, the probability that the program which has been requested to be recorded in behalf of the other recording schedule sharing apparatus by the other apparatus is scheduled to be viewed and listened to from the first becomes high. The present embodiment thus offers an advantage of making it easy for another recording schedule sharing apparatus to accept a request for recording of a program.

### Embodiment 18

A block diagram showing the structure of a recording schedule sharing apparatus in accordance with Embodiment 18 of the present invention is the same as that shown in FIG. 6 of above-mentioned Embodiment 4. In above-mentioned Embodiment 4, an example in which shared recording schedule information is used for the use of a recording request to another apparatus is explained, but the present invention is not limited to this example. For example, shared recording schedule information is used for inquiring of another apparatus about its recording schedules, comparing these recording schedules with the recording schedules of the apparatus itself, and, when an identical recording schedule is contained in both of them, canceling the identical recording schedule included in the recording schedules of the apparatus itself.

First, assume that when a user performs a recording reservation operation in any of recording schedule sharing apparatuses 1A and 1B, the recording schedule information processing means 14 only stores information about a recording schedule inputted thereto in the memory 18, but does not make any request for recording schedule information. When the user of the recording schedule sharing apparatus 1A desires to know information about the recording schedules of the other apparatuses, the recording schedule sharing apparatus 1A transmits a recording schedule information request message 50 to, for example, the recording schedule sharing apparatus 1B in the same way as that shown in above-mentioned Embodiment 4, and the recording schedule sharing apparatus 1A receives the recording schedule information 51 from the recording schedule sharing apparatus 1B.

The recording schedule information processing means 14 of the recording schedule sharing apparatus 1A reads the recording schedule information of the apparatus itself which is stored in the memory 18, compares this recording schedule information with the recording schedule information of the recording schedule sharing apparatus 1B, and, when there is a recording reservation which collides with a recording reservation in the recording schedule sharing apparatus 1B, deletes the recording reservation of the apparatus itself which is stored in the memory 18.

In this Embodiment 18, the recording schedule information processing means of a recording schedule sharing apparatus, when there is a recording reservation which collides with a recording reservation in another recording schedule sharing apparatus, cancels the recording reservation of the apparatus itself, as previously explained. However, the present invention is not limited to this example, and, when there is a recording reservation which collides with a recording reservation in another recording schedule sharing apparatus, the recording schedules of the other apparatus can be alternatively cancelled.

As mentioned above, this Embodiment 18 offers an advantage of being able to prevent an identical recording reservation from being made in two or more recording schedule sharing apparatuses, thereby providing more free disk space on each recording schedule sharing apparatus.

### Embodiment 19

A block diagram showing the structure of a recording schedule sharing apparatus in accordance with Embodiment 19 of the present invention is the same as that shown in FIG. 6 of above-mentioned Embodiment 4. In this Embodiment 19, as another use of recording schedule information shared, there is provided, for example, a method of using the recording schedule information in order for a user to search for a recorded program which he or she has missed.

Assume that each recording schedule sharing apparatus which constructs a recording schedule sharing system, after completing the recording of a program, keeps information about the recording schedule stored therein without erasing it during a predetermined time interval.

When a user who uses a recording schedule sharing apparatus desires to search for another user who has recorded a program which the user has missed, the recording schedule sharing apparatus makes a request of other recording schedule sharing apparatuses for provision of recording schedule information (including at least recording schedule information about previously-broadcast programs), and waits for provision of the recording schedule information (including at least recording schedule information about previously-broadcast programs) from other recording schedule sharing apparatuses. At this time, an instruction from the user is transferred to the recording schedule information request means 12 via the user input receiving means 11 and the recording schedule information processing means 14, and the recording schedule information acquiring means 13 receives the recording schedule information from other apparatuses.

Then, by causing the display means 21 to display the recording schedule information from other apparatuses, the recording schedule information processing means 14 enables the user who is searching for the missed program, to know whether or not there is another user who has recorded the program which the user desires to watch from the recording schedule information (including at least recording schedule information about previously-broadcast programs) provided from other recording schedule sharing apparatuses, and, when there is another user who has recorded the program which the user desires to watch, to know who the other user is.

As mentioned above, in accordance with this Embodiment 19, each recording schedule sharing apparatus, after completing the recording of a program, can keep information about the recording schedule stored therein without erasing it during a predetermined time interval, and can receive provision of recording schedule information containing previously-broadcast programs. Therefore, the present embodiment offers an advantage of being able to enable a user to know whether or not there is another user who has recorded a program which the user has missed, and, when there is another user who has recorded the program, to know who the other user is.

### Embodiment 20

In recording schedule sharing apparatuses in accordance with above-mentioned Embodiment 4, each recording schedule sharing apparatus which constructs the recording schedule sharing system is connected to the Internet, sharing of recording schedule information can be performed among two or more recording schedule sharing apparatuses arranged at distant places, as previously explained. As an alternative, recording schedule information can be shared among recording schedule sharing apparatuses which are connected to a domestic network (a home network).

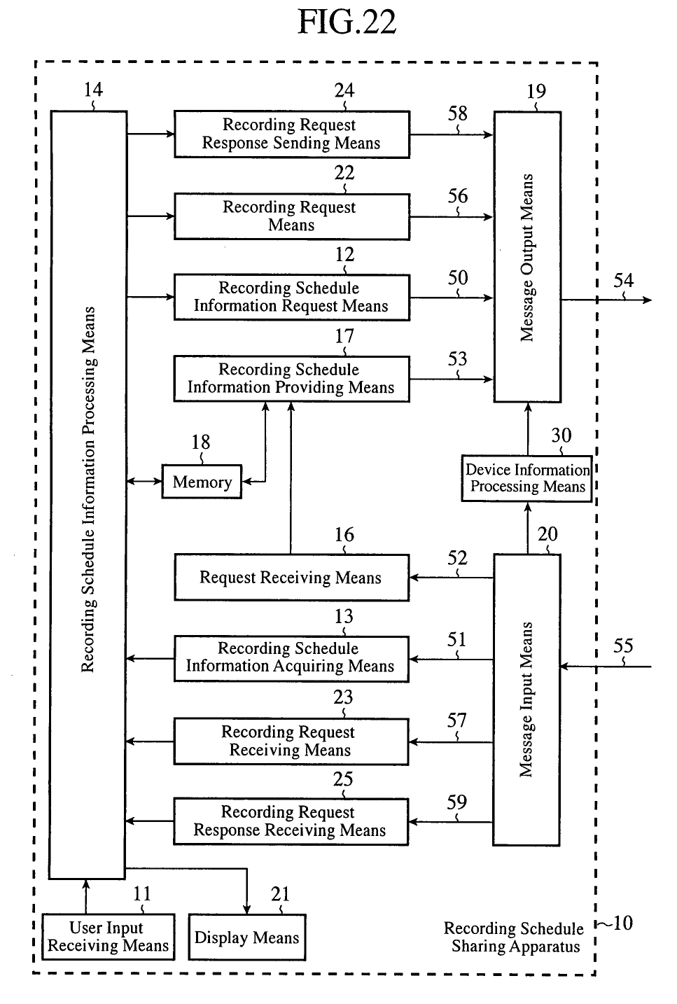

FIG. 22 is a block diagram showing the structure of a recording schedule sharing apparatus in accordance with Embodiment 20 of the present invention. This recording schedule sharing apparatus 10 additionally includes a device information processing means 30 in addition to the recording schedule sharing apparatus 10 shown in FIG. 9 of above-mentioned Embodiment 8, and the other components are the same as those designated by the same reference numerals as those shown in FIG. 9. In FIG. 22, the device information processing means 30 carries out transmission of a below-mentioned device search message, reception of a response message which is a response to the device search message, transmission of a device information request message, and reception of a device information message which is a response to the device information request message.

Next, the operation of a recording schedule sharing system will be explained.

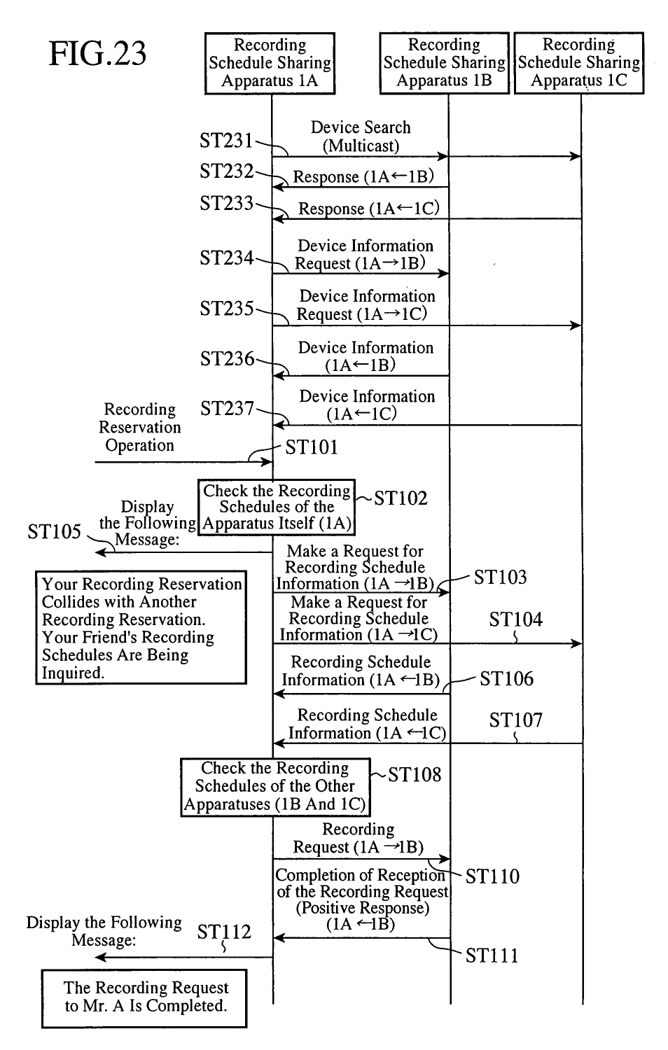

FIG. 23 is a sequence diagram for explaining the operation of the recording schedule sharing system in accordance with Embodiment 20 of the present invention.

When the power supply of a recording schedule sharing apparatus 1A is switched on and the recording schedule sharing apparatus then starts, the device information processing means 30, in step ST231, multicasts a device search message so as to search for other recording schedule sharing apparatuses connected to the home network. Information about the IP address of the recording schedule sharing apparatus 1A itself is included in this device search message.

When the device information processing means 30 of each of recording schedule sharing apparatuses 1B and 1C, in step ST232 and ST233, receives the device search message sent from the recording schedule sharing apparatus 1A, the device information processing means transmits a response message which is response to it to the recording schedule sharing apparatus 1A. An IP address which is used to specify the destination of this response message is acquired by extracting the IP address of the recording schedule sharing apparatus 1A included in the above-mentioned device search message. After that, this IP address is also used to specify the destination of other messages which are transmitted from each of the recording schedule sharing apparatuses 1B and 1C to the recording schedule sharing apparatus 1A. Information about the IP address of each of these recording schedule sharing apparatuses 1B and 1C themselves is included in the response message which each of the recording schedule sharing apparatuses 1B and 1C sends to the recording schedule sharing apparatus 1A.

When receiving these response messages, the device information processing means 30 of the recording schedule sharing apparatus 1A can know that the other recording schedule sharing apparatuses 1B and 1C exist on the network, and can also know the destination addresses (i.e., the IP addresses) which should be specified when, after that, sending messages to the other recording schedule sharing apparatuses 1B and 1C on the network.

The device information processing means 30 of the recording schedule sharing apparatus 1A, in steps ST234 and ST235, transmits a device information request message to each of the other recording schedule sharing apparatuses 1B and 1C in order to know detailed information about the capability of each of the other recording schedule sharing apparatuses 1B and 1C found out on the network. IP addresses which are used to specify the destinations of this device information request message are acquired by extracting the IP addresses of the recording schedule sharing apparatuses 1B and 1C included in the response messages which are responses to the above-mentioned device search message. After that, these IP addresses are also used to specify the destinations of other messages which are transmitted from the recording schedule sharing apparatus 1A to the recording schedule sharing apparatuses 1B and 1C.

When receiving the device information request message sent from the recording schedule sharing apparatus 1A, the device information processing means 30 of each of the recording schedule sharing apparatuses 1B and 1C, in steps ST236 and ST237, transmits a device information message to the recording schedule sharing apparatus 1A. This device information message of each of the recording schedule sharing apparatuses can include image quality information about the apparatus itself, which, for example, each of the recording schedule sharing apparatuses 1B and 1C supports, such as a resolution, a frame rate, a bit rate, or an encoding algorithm. When receiving this device information message, the recording schedule sharing apparatus 1A can know the detailed information about the capability of each of the other recording schedule sharing apparatuses 1B and 1C.

After that, when the user of the recording schedule sharing apparatus 1A, in step ST101, performs a recording reservation operation, and the recording schedule sharing apparatus 1A then, in step ST102, checks the recording schedules thereof and judges that it cannot accomplish the recording reservation which the user desires to make therewithin, the recording schedule sharing apparatus 1A, in steps ST103 and ST104, transmits a recording schedule information request message to each of the other apparatuses (the recording schedule sharing apparatuses 1B and 1C), in step ST105, displays a message for the user, and, in steps ST106 and ST107, acquires a recording schedule information message from each of the other apparatuses (the recording schedule sharing apparatuses 1B and 1C).

The recording schedule information processing means 14 of the recording schedule sharing apparatus 1A, in step ST108, checks the recording schedules of each of the other apparatuses (the recording schedule sharing apparatuses 1B and 1C), checks to see whether or not there are other apparatuses which can carry out the recording which the user desires, selects one of the other apparatuses which can carry out the recording which the user desires, and, in step ST110, transmits a recording request message, via the recording request means 22, to the apparatus (in this case, the recording schedule sharing apparatus 1B). When receiving the recording request message sent from the recording schedule sharing apparatus 1A via the recording request receiving means 23, the recording schedule information processing means 14 of the recording schedule sharing apparatus 1B checks to see whether the recording schedule information processing means can accept the recording request, and, when judging that the recording schedule information processing means can accept the recording request, in step ST111, transmits, as a positive response, a recording request reception completion message to the recording schedule sharing apparatus 1A via the recording request response sending means 24. When receiving this recording request reception completion message via the recording request response receiving means 25, the recording schedule information processing means 14 of the recording schedule sharing apparatus 1A, in step ST112, displays a message indicating that the recording request has been completed for the user via the display means 21.

As the protocol for use in transmission and reception of messages between the recording schedule sharing apparatus 1A and the recording schedule sharing apparatuses 1B and 1C which are explained in this Embodiment 20, universal plug and play (UPnP: Universal Plug and Play) can be used. When UPnP is used as the protocol for use in transmission and reception of messages, the above-mentioned messages which are transmitted between the apparatuses are concretely transmitted as the following messages:

(1) The device search message: an HTTP M-SEARCH (or SEARCH) message,

(2) The response message (which is a response to the device search message): an HTTP OK message,

(3) The device information request message: an HTTP GET message,

(4) The device information message: an HTTP OK message (device information is described in XML (Extensible Markup Language)),

(5) The recording schedule information request message: an HTTP POST message,

(6) The recording schedule information message: an HTTP OK message (recording schedule information is described in XML),

(7) The recording request message: an HTTP POST Message, and

(8) The recording request reception completion message: an HTTP OK message.

In this Embodiment 20, the device information message of each of the recording schedule sharing apparatuses 1B and 1C includes image quality information about the apparatus itself, which each of the recording schedule sharing apparatuses 1B and 1C supports, such as a resolution, a frame rate, a bit rate, or an encoding algorithm, as previously explained. The present invention is not limited to this example, and the image quality information can be alternatively transmitted while being included in the recording schedule information message.

As mentioned above, in accordance with this Embodiment 20, each recording schedule sharing apparatus which constructs the recording schedule sharing system is connected to the home network. Therefore, the present embodiment offers an advantage of being able to, by connecting two or more recording schedule sharing apparatuses which a user owns to a home network, enable the user to handle the two or more recording schedule sharing apparatuses with a feeling that two or more recording schedule sharing apparatuses look like one apparatus with large disk space, thereby improving the convenience of each recording schedule sharing apparatus.

Furthermore, in accordance with this Embodiment 20, as the protocol for use in transmission and reception of messages between the recording schedule sharing apparatuses, universal plug and play is used. Therefore, the present embodiment offers another advantage of being able to eliminate the necessity to assign a mail address to each recording schedule sharing apparatus, and hence to make it easy to make settings.

In this Embodiment 20, when the recording schedule sharing apparatus 1A transmits the recording schedule information request message to each of the other apparatuses (the recording schedule sharing apparatuses 1B and 1C), the recording schedule sharing apparatus can include a keyword showing, for example, the genre of broadcasting or a part of the title names of programs, into the recording schedule information request message so as to cause each of the other apparatuses to select only recording schedules of broadcasting which match this keyword, and to transmit the recording schedules to the recording schedule sharing apparatus 1A as the recording schedule information message. As a result, because the size of the recording schedule information message is reduced, an advantage of being able to reduce the load on the network is provided.

### INDUSTRIAL APPLICABILITY

As mentioned above, the recording schedule sharing system and the recording schedule sharing apparatus in accordance with the present invention are suitable for, for example, applications in which recording schedule information is shared among two or more apparatuses, and a request for recording in behalf of an apparatus is implemented efficiently.

1. A recording schedule sharing system comprising:
a first recording schedule sharing apparatus which makes a request for recording schedule information, and which acquires and checks recording schedule information provided thereto; and
a second recording schedule sharing apparatus which receives the request for recording schedule information from said first recording schedule sharing apparatus, and which provides recording schedule information held thereby to said first recording schedule sharing apparatus.

2. The recording schedule sharing system according to claim 1, characterized in that said first and the second recording schedule sharing apparatuses are connected to each other via a server.

3. The recording schedule sharing system according to claim 1, characterized in that said first and the second recording schedule sharing apparatuses are connected to an Internet.

4. The recording schedule sharing system according to claim 1, characterized in that said first and the second recording schedule sharing apparatuses are connected to a home network.

5. A recording schedule sharing apparatus comprising:
a recording schedule information request means for making a request of another apparatus for recording schedule information;
a recording schedule information acquiring means for acquiring the recording schedule information provided thereto from said other apparatus; and
a recording schedule information processing means for checking recording schedules of said other apparatus by using the recording schedule information acquired by said recording schedule information acquiring means.

6. The recording schedule sharing apparatus according to claim 5, characterized in that said apparatus comprises a request receiving means for receiving a request for recording schedule information from said other apparatus and a recording schedule information providing means for providing the recording schedule information to said other apparatus in response to the request received by said request receiving means.

7. The recording schedule sharing apparatus according to claim 6, characterized in that each of the request for the recording schedule information by said recording schedule information request means, the acquisition of the recording schedule information by said recording schedule information acquiring means, the reception of the request for the recording schedule information by said request receiving means, and the provision of the recording schedule information by said recording schedule information providing means is carried out using an e-mail or via a telephone line.

8. The recording schedule sharing apparatus according to claim 5, characterized in that said apparatus comprises a user input receiving means for receiving an operational input from a user, and said recording schedule information request means, makes a request of the other apparatus for recording schedule information according to a recording reservation operation received by said user input receiving means.

9. The recording schedule sharing apparatus according to claim 8, characterized in that said apparatus comprises a memory for storing recording schedule information of said apparatus itself, and said recording schedule information process means refers to the recording schedule information stored in said memory according to a recording reservation operation received by said user input receiving means, and, when a recording reservation is available, writes received recording schedule information in said memory as new recording schedule information, whereas when no recording reservation is available, said recording schedule information process means causes said recording schedule information request means to make a request for recording schedule information and checks the recording schedules of the other apparatus according to the recording schedule information acquired by said recording schedule information acquiring means.

10. The recording schedule sharing apparatus according to claim 5, characterized in that said apparatus comprises a display means for displaying a message for a user, and said recording schedule information process means causes said display means to display a message according to either a state or a result of the checking of the recording schedules of said other apparatus.

11. The recording schedule sharing apparatus according to claim 5, characterized in that said apparatus comprises a display means for displaying a message for a user, and said recording schedule information processing means causes said display means to display the recording schedule information acquired by said recording schedule information acquiring means.

12. The recording schedule sharing apparatus according to claim 5, characterized in that said apparatus transmits and receives messages to and from said other apparatus using universal plug and play protocols.

13. The recording schedule sharing apparatus according to claim 5, characterized in that said apparatus comprises a recording request means for making a recording request of said other apparatus, and said recording schedule information processing means causes said recording request means to make a recording request according to a result of the checking of the recording schedules of said other apparatus.

14. The recording schedule sharing apparatus according to claim 13, characterized in that said recording schedule information processing means causes said recording request means to make a recording request of another apparatus, which said recording schedule information processing means has selected on a basis of apparatus capability information, on a priority basis.

15. The recording schedule sharing apparatus according to claim 13, characterized in that said recording schedule information processing means causes said recording request means to make a recording request of another apparatus, which a user has selected, on a priority basis.

16. The recording schedule sharing apparatus according to claim 13, characterized in that said apparatus comprises a user input receiving means for receiving an operational input from a user, and a copy enable or disable inquiring means for inquiring of a right holder about whether or not a content can be copied, and said recording schedule information process means causes said copy enable or disable inquiring means to inquire about whether or not a content can be copied on a basis of the operational input inputted by said user input receiving means.

17. The recording schedule sharing apparatus according to claim 16, characterized in that on a basis of a reply from the right holder to the inquiry about whether or not the content can be copied, said recording schedule information processing means includes information indicating that approval of contents to the right holder in the recording request outputted by said recording request means.

18. The recording schedule sharing apparatus according to claim 5, characterized in that said apparatus comprises a user input receiving means for receives an operational input from a user, a first memory for stores recording schedule information of said apparatus itself according to a recording reservation operation received by said user input receiving means, and a second memory for storing the recording schedule information of said other apparatus acquired by said recording schedule information acquiring means, and, when said user input receiving means receives a user's recording reservation operation, said recording schedule information processing means checks the recording schedule information of said apparatus itself stored in the said first memory, whereas when the recording reservation operation is not received by said apparatus itself, said recording schedule information processing means checks the recording schedules of said other apparatus with reference to the recording schedule information stored in said second memory.

19. The recording schedule sharing apparatus according to claim 5, characterized in that said recording schedule information request means makes a request for viewing-and-listening schedule information of said other apparatus, said recording schedule information acquiring means acquires the viewing-and-listening schedule information provided thereto, and said recording schedule information processing means selects an apparatus of which said recording schedule information processing means makes a request for recording on a basis of the recording schedule information and the viewing-and-listening schedule information acquired by said recording schedule information acquiring means.

20. The recording schedule sharing apparatus according to claim 5, characterized in that said apparatus comprises a memory for storing recording schedule information of the apparatus itself, and said recording schedule information process means compares the recording schedule information of said other apparatus acquired by said recording schedule information acquiring means with the recording schedule information of the apparatus itself stored in said memory, and, when both said apparatus itself and said other apparatus schedule to record an identical program, cancels the duplicated recording schedules of either said apparatus itself or said other apparatus.

21. The recording schedule sharing apparatus according to claim 5, characterized in that the recording schedule information for which the recording schedule information request means makes a request includes past recording schedule information about already-broadcast programs.

22. A recording schedule sharing apparatus comprising:
a request receiving means for receiving a request for recording schedule information from another apparatus; and
a recording schedule information providing means for providing the recording schedule information to said other apparatus in response to the request received by said request receiving means.

23. The recording schedule sharing apparatus according to claim 22, characterized in that said recording schedule information providing means provides the recording schedule information including a date on which a program is scheduled to be recorded.

24. The recording schedule sharing apparatus according to claim 22, characterized in that said recording schedule information providing means provides the recording schedule information including a channel and a title of a program.

25. The recording schedule sharing apparatus according to claim 22, characterized in that said apparatus transmits and receives messages to and from said other apparatus using universal plug and play protocols.

26. The recording schedule sharing apparatus according to claim 22, characterized in that said apparatus comprises a recording request receiving means for receiving a recording request from said other apparatus and a recording request response sending means for sending out a recording request response message to said other apparatus, and said recording schedule information process means checks to see whether said apparatus can carry out recording in behalf of said other apparatus in response to the recording request received by said recording request receiving means, and, if not, causes said recording request response sending means to send out a recording request response message indicating a rejection of the recording request.

27. The recording schedule sharing apparatus according to claim 22, characterized in that said apparatus comprises a recording request receiving means for receiving a recording request from another apparatus and a recording request response sending means for sending out a recording request response message to said other apparatus, and, when said apparatus cannot carry out recording in behalf of said other apparatus in response to the recording request received by said recording request receiving means, said recording schedule information process means causes said recording request response delivery means to send out either a recording request target change notification indicating that said recording schedule information process means has made a request of a still another apparatus for recording or a notification indicating that the request for the recording in behalf of said other apparatus is cancelled to said other apparatus.
